(19) United States
(12) Patent Application Publication
(10) Pub. No.: US 2018/0009997 A1
(43) Pub. Date: Jan. 11, 2018

(54) HARDCOAT AND RELATED COMPOSITIONS, METHODS, AND ARTICLES

(71) Applicant: Dow Corning Corporation, Midland, MI (US)

(72) Inventors: Dorab Edul Bhagwagar, Saginaw, MI (US); Fengqiu Fan, Midland, MI (US)

(73) Assignee: Dow Corning Corporation, Midland, MI (US)

(21) Appl. No.: 15/544,894

(22) PCT Filed: Jan. 7, 2016
(86) PCT No.: PCT/US2016/012448

§ 371 Date: Jul. 20, 2017

Related U.S. Application Data
(60) Provisional application No. 62/111,216, filed on Feb. 3, 2015.

(51) Int. Cl. C09D 5/16; C08K 3/36; C08J 7/04; C09D 183/08; C09D 7/12

(52) U.S. Cl. CPC C09D 5/1687; C09D 183/08; C09D 7/1266; C09D 5/1675; C08J 7/047; C08K 3/36; C08J 2369/00; C08J 2483/08

(57) ABSTRACT

A hardcoat comprising a host matrix, a nanoporous filler in which the dispersed phase is a gas, and nonporous nanoparticles. Also, coating and curable compositions useful for preparing the hardcoat, methods of preparing the hardcoat and compositions, articles comprising the hardcoat or composition, and uses thereof.

The present invention generally relates to a hardcoat, coating and curable compositions useful for preparing the hardcoat, methods of preparing the hardcoat and compositions, articles comprising the hardcoat or compositions, and uses thereof, and methods of making the articles.

We (the present inventors) have discovered and solved a problem of balancing competing coating functions and properties. Until now, we would formulate a coating to modify surface properties of a substrate, such as smudge and stain resistance and/or water repellency, but the coating would fail to adequately adhere to or protect the substrate from scratching or impact. Alternatively, we would formulate a coating to adhere to and protect a substrate from scratching or impact, but the coating would fail to resist smudging or stains, or repel water. We solve this problem by discovering a hardcoat that is stain or smudge resistant, water repellant, protects the substrate from scratching or impact, and still adheres to the substrate.

### SUMMARY OF THE INVENTION

The present invention generally relates to a hardcoat, coating and curable compositions useful for preparing the hardcoat, methods of preparing the hardcoat and compositions, articles comprising the hardcoat or compositions, and uses thereof, and methods of making the articles. The hardcoat uses an effective combination of fillers comprising a nanoporous filler in which the dispersed phase is a gas and a filler comprising nonporous nanoparticles. Embodiments include:

A curable composition useful for making the hardcoat, the curable composition consisting essentially of a mixture of the following constituents: a matrix precursor containing curable groups; the nanoporous filler; and the nonporous nanoparticles; wherein the curable composition is substantially free or free of a vehicle.

A hardcoat comprising a host matrix, a nanoporous filler in which the dispersed phase is a gas, and nonporous nanoparticles.

A method of preparing the hardcoat comprising curing the curable composition.

A coating composition useful for preparing the curable composition, and thus for making the hardcoat, the coating composition comprising a mixture of a matrix precursor containing curable groups; a curing agent for the matrix precursor; the nanoporous filler; the nonporous nanoparticles; and a vehicle.

A method of preparing the curable composition by removing the vehicle from the coating composition.

An article comprising the curable composition disposed on a substrate.

A method of preparing the article, the method comprising removing the vehicle from the coating composition on the substrate so as to make an article comprising the curable composition on the substrate.

An article comprising the hardcoat disposed on a substrate.

A method of preparing the article, the method comprising curing the curable composition on the substrate so as to make the article comprising the hardcoat on the substrate.

An article comprising the coating composition disposed on a substrate.

A method of preparing the article, the method comprising applying the coating composition to the substrate so as to make the article comprising the coating composition on the substrate.

Use of the hardcoat in an article in need of hardness protection.

### DETAILED DESCRIPTION OF THE INVENTION

The Summary and Abstract are hereby incorporated by reference here. The invention provides a hardcoat, a coating composition, a curable composition, methods of preparing the hardcoat and compositions, articles comprising the hardcoat or compositions, and uses thereof.

The coating composition may be used to prepare a curable composition by removing the vehicle from the coating composition, as described herein. The coating composition may also be used to prepare an article comprising the coating composition disposed on a substrate, as described herein. The curable composition and article independently have excellent physical and chemical properties and are suitable for many different uses and applications.

The curable composition may be prepared by any suitable method, including the method of removing the vehicle from the coating composition as described herein. Methods of preparing the curable composition, however, are not limited to those methods. For example, the curable composition may be prepared directly from its constituents without using a vehicle when the matrix precursor containing curable groups is a liquid and is used in an amount sufficient to enable preparing of a mixture that is both curable and suitable for coating a substrate.

The coating or curable composition may be used to prepare the hardcoat by curing the coating or curable composition, as described herein. The coating or curable composition may also be used to prepare an article comprising the coating or curable composition disposed on a substrate, as described herein. The hardcoat and article independently have excellent physical properties and are suitable for many different end uses and applications.

The invention has technical and non-technical advantages. We found that the inventive hardcoat comprises a host matrix filled with a filler combination comprising nonporous nanoparticles as one filler and, as different filler, a nanoporous filler in which the dispersed phase is a gas. Without wishing to be bound by theory, we believe that the host matrix provides stain or smudge resistance and/or water repellency and bonds strongly to a substrate and the filler combination. We also believe that the filler combination provides better scratch and impact resistance than either filler used alone. Also, the filler combination does not prevent the host matrix from exhibiting smudge and stain resistance, water repellency, easy-to-clean, and adherence properties. Addition of the nanoporous filler in which the dispersed phase is a gas to a curable composition also comprising a matrix precursor containing curable groups and nonporous nanoparticles improves properties of a hardcoat composition prepared therefrom. The improvements independently comprise increased pencil hardness, typically achieved without sacrificing flexibility or elongation-at-break properties, and imparting the hardcoat composition with an anti-glare property. Certain aspects of this invention may independently solve additional problems and/or have other advantages.

As used herein, “may” confers a choice, not an imperative. “Optionally” means is absent, alternatively is present. In any one embodiment, any one of the open-ended terms “comprising,” “comprises,” “comprised of,” and the like may be replaced by a respective one of the closed-ended terms “consisting of,” “consists of,” “consisted of,” and the like. “Contacting” means bringing into physical contact. “Operative contact” comprises functionally effective touching, e.g., as for modifying, coating, adhering, sealing, or filling. The operative contact may be direct physical touching, alternatively indirect touching. All U.S. patent application publications and patents referenced herein, or a portion thereof if only the portion is referenced, are hereby incorporated herein by reference to the extent that incorporated subject matter does not conflict with the present description, which would control in any such conflict. All % are by weight unless otherwise noted. All “wt %” (weight percent) are, unless otherwise noted, based on total weight of all ingredients used to make the composition, which adds up to 100 wt %. Any Markush group comprising a genus and subgenus therein includes the subgenus in the genus, e.g., in “R is hydrocarbyl or alkenyl,” R may be alkenyl, alternatively R may be hydrocarbyl, which includes, among other subgenuses, alkenyl. The term “silicone” includes linear, branched, or a mixture of linear and branched polyorganosiloxane macromolecules.

As used herein, the term “aerogel” is a gel comprised of a mesoporous solid in which the dispersed phase is a gas. A “silica aerogel” is a silicon dioxide gel comprised of a mesoporous solid in which the dispersed phase is a gas. A typical silica aerogel contains micropores, mesopores and macropores, but the majority of pores, and average pore size, fall in the mesopore size range with relatively few micropores.

The term “BET surface area” (Brunaur, Emmett and Teller) may be measured according to ASTM D1993-03(2013) (Standard Test Method for Precipitated Silica-Surface Area by Multipoint BET Nitrogen Adsorption).

As used herein, “bivalent” means having two free valences. The term “bivalent” may be used interchangeably herein with the term “divalent.”

The transitional phrase “consists essentially of” and like transitional phrases such as “consisting essentially of” when used with the curable composition mean the curable composition is substantially free or free of a vehicle, but otherwise may contain any other constituent. The transitional phrases permit, however, the curable composition to contain an amount of water effective for use as a filler treating agent, as described later.

The term “colloidal silica” used herein may have a primary particle size from 2 nm to 100 nm.

As used herein, a “curing agent” is a substance that is used for starting or enhancing reaction of the matrix precursor to prepare the host matrix.

The term “fumed silica” used herein may have a primary particle size from 5 nm to 50 nm, a BET surface area from 50 to 600 square meters per gram (m²/g), a bulk density from 160 to 190 kilograms per cubic meter (kg/m³), or a combination of any two thereof or a combination of all three thereof.

The term “macroporous material” means a solid containing pores with an average pore diameter from greater than 50 nm to 100 nm and in which the dispersed phase is a gas. The term “mesoporous material” means a solid containing pores with an average pore diameter from 2 nm to 50 nm and in which the dispersed phase is a gas. The term “microporous material” means a solid containing pores with an average pore diameter of from greater than 0.5 nm to less than 2 nm and in which the dispersed phase is a gas.

As used herein, a “metal-organic framework” or MOF comprises, consists essentially of, or consists of metal ions or clusters coordinated to organic molecules so as to prepare a three-dimensional microporous structure in which the dispersed phase is a gas. The organic molecules may provide rigidity to the MOF.

As used herein, the term “nanoporous filler” means a material containing pores with an average pore diameter (average pore size) of from 0.5 nanometer (nm) to less than 100 nm and in which the dispersed phase is a gas. The material may consist of a regular organic or inorganic framework defining a regular, porous structure. Any reference to pore diameter (or pore size) herein shall mean average pore diameter (average pore size), e.g., volume average pore diameter (volume average pore size), unless otherwise stated or contextually implied. The average pore diameter (average pore size) may be measured according to the gas adsorption method of King K. S. W. et al. described later.

As used herein, the term “nonporous” means having 0% porosity or at most a porosity or apparent porosity as measured by ASTM D1993-03(2013) of from 0% to 10%, alternatively from 0% to 5%, alternatively from 0% to 1%, alternatively 0%.

The term “polyfunctional” when used in a chemical name to modify an indicated functional group means a compound having two or more (“poly”) of the indicated functional groups. The compound may be a monomer or a prepolymer.

As used herein the term “porous” means having a porosity, typically an apparent porosity, as measured by ASTM D1993-03(2013) of from 50% to 99%, alternatively from 70% to 98%, alternatively from 80% to 97%, alternatively from 90% to 95%. The term “porosity” means a void fraction relative to total volume, expressed as a percent. The term “apparent porosity” is an accessible void fraction (not including closed pore volume) relative to total volume, expressed as a percent, and is what is measured by ASTM D1993-03(2013).

The term “primary particle size” means dimension of discrete particles without effects of agglomeration or aggregation and may be measured according to ASTM B822-10 (Standard Test Method for Particle Size Distribution of Metal Powders and Related Compounds by Light Scattering) or using a particle size analyzer model Malvern Mastersizer S made by Malvern Instruments, Worcestershire, United Kingdom or Microtrac S3500 made by Microtrac Inc., Pennsylvania, USA.

The term “univalent” means having one free valence. The term “univalent” may be used interchangeably herein with the term “monovalent.” The term “univalent organic group” means an organyl or an organoheteryl. The term “univalent organic group” may be used interchangeably herein with the term “monovalent organic group.”

The term “unsaturated aliphatic group” is a nonaromatic substituent that contains at least one aliphatic unsaturated bond. The aliphatic unsaturated bond may be a carbon-carbon double bond (C═O) or a carbon-carbon triple bond (C═C), although the aliphatic unsaturated bond is typically a double bond.

As used herein, a “vehicle” is an amorphous liquid that is used in appreciable amount (i.e., greater than stoichiometric quantities relative to the matrix precursor and/or optional modifier of the coating composition) to convey other constituents of a first composition through a chemical or physical process to give a second composition. Typically in practice, the vehicle, once it is no longer needed for the conveying, it is eventually removed physically from the second composition to give a third composition that is substantially free or free of the vehicle. The third composition then may subsequently undergo another chemical process, such as curing, or physical process, such as heating above the boiling point of the vehicle, which may or may not have been possible, or which may have been significantly less effective, if done in the presence of the vehicle. Typically the vehicle is inert to the process(es) used to make the second composition. The vehicle may be termed a solvent when it is a substance that is widely known for having general solvating properties, whether or not the substance dissolves a particular constituent of a present composition. Examples of suitable vehicles that are widely known for having general solvating properties are organic solvents and silicone fluids.

As used herein, “zeolite” is a microporous solid composed of an aluminosilicate and in which the dispersed phase is a gas.

Some inventive embodiments include the following numbered aspects.

Aspect 1. A curable composition consisting essentially of (i.e., substantially free or free of a vehicle, excepting optionally water) the following mixture of constituents: a matrix precursor containing curable groups; a nanoporous filler in which the dispersed phase is a gas; and nonporous nanoparticles; wherein the nanoporous filler is at a concentration of from 0.1 to 10 weight percent (wt %), based on total weight of the curable composition; and wherein the nonporous nanoparticles are at a concentration from 5 to 60 wt %, based on total weight of the curable composition. Alternatively, the concentration of the nanoporous filler may be from 0.5 to 5 wt %, alternatively from 1 to 3 wt %, alternatively from 1.6 to 2.4 wt %, alternatively 2±0.3 wt %, all based on total weight of the curable composition. Alternatively, the concentration of the nonporous nanoparticles may be from 10 to 55 wt %, alternatively from 20 to 50 wt %, alternatively from 30 to 39 wt %, alternatively 35±3 wt %, all based on total weight of the curable composition. The porosity or apparent porosity may be measured according to ASTM D1993-03(2013). Alternatively, the porosity of the nonporous particles may be from 0% to 5%, alternatively from 0% to 1%, alternatively from >0% to 10%, alternatively from >0% to 5%, alternatively from >0% to 1%, alternatively 0%. In some embodiments the nanoporous filler is a macroporous material, alternatively a mesoporous material, alternatively a microporous material, alternatively a blend of at least two of the macroporous material, mesoporous material, and microporous material. The nanoporous filler may have an average pore diameter or size of from 2 nm to 99 nm, alternatively from 2 nm to 50 nm, alternatively from >50 nm to 99 nm, alternatively from 5 nm to 50 nm, alternatively from 10 nm to 90 nm, alternatively from 20 nm to 80 nm, alternatively from 20 nm to 40 nm. The average pore diameter (average pore size) may be measured according to the gas adsorption method of King K. S. W. et al. described later.

Aspect 2. The curable composition of aspect 1 wherein the matrix precursor comprises a sol-gel, a polyfunctional isocyanate, a polyfunctional acrylate, or a polyfunctional curable organosiloxane. The matrix precursor may comprise the sol-gel, alternatively the polyfunctional isocyanate, alternatively the polyfunctional acrylate, alternatively the polyfunctional curable organosiloxane. The polyfunctional curable organosiloxane may comprise an organosiloxane having on average, per molecule, at least two unsaturated aliphatic groups. The unsaturated aliphatic groups may be unsubstituted unsaturated (C₂-O₄) aliphatic groups, e.g., vinyl groups, propen-3-yl, 1-methyl-ethen-1-yl, or buten-4-yl.

Aspect 3. The curable composition of aspect 2 wherein the matrix precursor comprises the polyfunctional acrylate, and the polyfunctional acrylate comprises an organic polyfunctional acrylate or a silicone-based polyfunctional acrylate.

Aspect 4. The curable composition of any one of aspects 1-3 wherein the nanoporous filler is an aerogel, a metal-organic framework, a zeolite, or a combination of any two or more thereof, wherein the aerogel, metal-organic framework or zeolite comprises particles, which are dispersed in the matrix precursor.

Aspect 5. The curable composition of aspect 4 wherein the nanoporous filler is the metal-organic framework (MOF) or zeolite. The nanoporous filler may be a MOF, alternatively a zeolite.

Aspect 6. The curable composition of aspect 4 wherein the nanoporous filler is the aerogel.

Aspect 7. The curable composition of aspect 6 wherein the nanoporous filler is a silica aerogel and the silica aerogel comprises particles having a diameter of from 1 micrometer (μm) to 50 μm.

Aspect 8. The curable composition of any one of aspects 1-7 wherein the nonporous nanoparticles are colloidal silica, fumed silica, or a combination of colloidal and fumed silicas.

Aspect 9. The curable composition of aspect 8 wherein the nonporous nanoparticles are surface-treated colloidal silica, surface-treated fumed silica, or a combination thereof, wherein the surface treatment independently is performed by contacting corresponding untreated nonporous nanoparticles with an organoalkoxysilane having an aliphatic unsaturated bond to give the surface-treated nonporous nanoparticles.

Aspect 10. The curable composition of any one of aspects 1-9 further consisting essentially of a constituent: a curing agent for the matrix precursor, wherein the curing agent is a curing initiator or a curing catalyst

Aspect 11. The curable composition of aspect 10 wherein the curing agent is a photopolymerization initiator or a polymerization catalyst

Aspect 12. The curable composition of any one of aspects 1-11 wherein the mixture further consists essentially of a constituent: a modifier containing, per molecule, one or more functional groups useful for forming one or more covalent bonds to at least one of the aforementioned constituents such that the modifier would form a covalently-bound portion of the hardcoat, wherein the modifier is dispersed in the curable composition at from 0.05 to 5 wt %, based on total weight of the curable composition. Alternatively, the concentration of the modifier may be from 0.1 to 2 wt %, alternatively from 0.1 to 1 wt %, alternatively from 0.2 to 0.8 wt %, alternatively 0.4±0.1 wt %, all based on total weight of the curable composition.

Aspect 13. The curable composition of aspect 12, wherein the modifier is: a fluoro-substituted compound having at least one unsaturated aliphatic group; an organopolysiloxane having at least one acrylate group; or a combination of the fluoro-substituted compound and the organopolysiloxane.

Aspect 14. The curable composition of aspect 13 wherein the modifier comprises the fluoro-substituted compound, which: (i) is partially fluorinated; (ii) comprises a perfluoropolyether segment; or (iii) both (i) and (ii).

Aspect 15. The curable composition of aspect 13 or 14 wherein the modifier comprises the fluoro-substituted compound, which comprises said perfluoropolyether segment, said perfluoropolyether segment comprising groups of general formula (1): —(C₃F₆O)ₓ₁—(C₂F₄O)_{y1}—(CF₂)_{z1}-(a1); wherein subscripts x1, y1, and z1 are each independently selected from 0 and an integer from 1 to 40, with the proviso that x1, y1, and z1 are not simultaneously 0.

Aspect 16. The curable composition of any one of aspects 13 to 15 wherein the modifier comprises the fluoro-substituted compound, which comprises the reaction product of a reaction of: a triisocyanate and a mixture of a perfluoropolyether compound having at least one active hydrogen atom; and a monomeric compound having an active hydrogen atom and a functional group other than the active hydrogen atom.

Aspect 17. The curable composition of aspect 16 wherein the perfluoropolyether compound has at least one terminal hydroxy group.

Aspect 18. The curable composition of aspect 16 or 17 wherein the fluoro-substituted compound is prepared by reacting the triisocyanate and the perfluoropolyether compound together to prepare a reaction intermediate, and then reacting the reaction intermediate and the monomeric compound together to prepare the modifier that is the fluoro-substituted compound.

Aspect 19. The curable composition of aspect 12 wherein the modifier comprises a fluorinated compound having the general formula (1):

R¹Xₐ(Y¹)_{d}SiRR¹Oₑ(Y¹)_{f}X¹_{g}SiR₃₋ⱼR¹ⱼ]ₖ

(1) wherein each R is an independently selected substituted or unsubstituted hydrocarbyl group; each R¹ is independently selected from R, —Y-R_{f}, and a (meth)acrylate functional group; R_{f} is a fluoro-substituted group; Y is a covalent bond or a bivalent linking group; each Y¹ is independently a covalent bond or a bivalent linking group; X has the general formula (2):

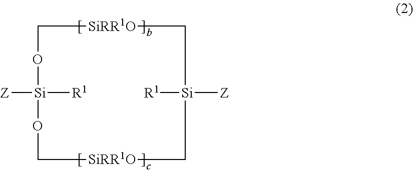

X¹ has the general formula (3):

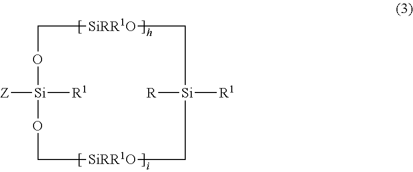

Z is a covalent bond; subscripts a and g are each 0 or 1, with the proviso that when a is 1, g is 1; subscripts b and c are each 0 or an integer from 1 to 10, with the proviso that when a is 1, at least one of b and c is at least 1; subscripts d and f are each independently 0 or 1; subscript e is 0 or an integer from 1 to 10; subscripts h and i are each 0 or an integer from 1 to 10, with the proviso that when g is 1, at least one of h and i is at least 1; subscript j is 0 or an integer from 1 to 3; and subscript k is 0 or 1, with the provisos that k is 1 when a and g are each 0 and k is 0 when g is 1; with the proviso that a, e, and g are not simultaneously 0; and wherein at least one R¹ of said fluorinated compound is a (meth)acrylate functional group and at least one R¹ of said fluorinated compound is represented by —Y-R_{f}.

Aspect 20. The curable composition of aspect 19 wherein subscripts a, d, f, and g are each 0, subscript e is an integer from 1 to 10, and subscript k is 1 such that said fluorinated compound has the general formula (4):

R¹SiRR¹OₑSiR₃₋ⱼR¹ⱼ (4);

wherein R, R¹, and subscripts e and j are each defined in aspect 19.

Aspect 21. The curable composition of aspect 19 wherein subscripts a and g are each 1 and subscript k is 0 such that said fluorinated compound has the general formula (5):

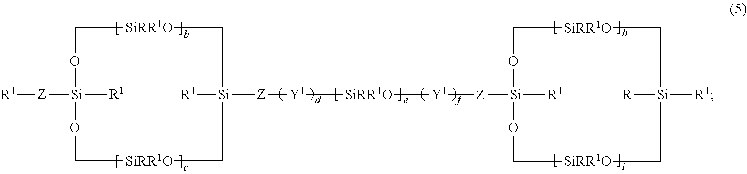

wherein R, R¹, Z, Y¹, and subscripts b, c, d, e, f, h, and i are each defined in aspect 19.

Aspect 22. The curable composition of aspect 19 wherein subscripts a, d, e, f, and k are each 0 such that said fluorinated compound has the general formula (6):

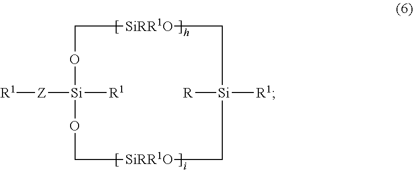

wherein R, R¹, Z, and subscripts h and i are each defined in aspect 19.

Aspect 23. The curable composition of aspect 19 or 21 wherein each Y¹ is independently said bivalent linking group, said bivalent linking group being independently selected from the group of a hydrocarbylene group, a heterohydrocarbylene group, or an organoheterylene group.

Aspect 24. The curable composition of any one of aspects 19-23 wherein R_{f}: (i) is partially fluorinated; (ii) comprises a perfluoropolyether segment; or (iii) both (i) and (ii).

Aspect 25. The curable composition of aspect 24 wherein R_{f} comprises said perfluoropolyether segment, said perfluoropolyether segment comprising groups of general formula (7): —(C₃F₆O)ₓ—(C₂F₄O)_{y}—(CF₂)_{z}-(7); wherein subscripts x, y, and z are each independently selected from 0 and an integer from 1 to 40, with the proviso that x, y, and z are not simultaneously 0.

Aspect 26. The curable composition of any one of aspects 19-25 wherein Y is said bivalent linking group, said bivalent group represented by Y having the general formula (8): —(CH₂)ₘ—O—(CH₂)ₙ-(8); wherein m and n are each integers independently from 1 to 5.

Aspect 27. The curable composition of any one of aspects 19-26 comprising two or more (meth)acrylate functional groups represented by R¹.

Aspect 28. The curable composition of any one of aspects 19-27 wherein one R¹ is represented by —Y-R_{f}.

Aspect 29. The curable composition of aspect 13 wherein the modifier comprises the organopolysiloxane having at least one acrylate group, wherein the organosiloxane having at least one acrylate group comprises the reaction product of a Michael addition reaction of an amino-substituted organopolysiloxane and a polyfunctional acrylate.

Aspect 30. The curable composition of any one of aspects 1-29 consisting essentially of a mixture of constituents: the matrix precursor containing curable groups, wherein the matrix precursor is a polyfunctional acrylate; a curing agent for the matrix precursor, wherein the curing agent comprises a photopolymerization initiator; the nanoporous filler, wherein the nanoporous filler is a silica aerogel; the nonporous nanoparticles, wherein the nonporous nanoparticles are colloidal silica; and a modifier comprising a combination of a fluoro-substituted compound having at least one unsaturated aliphatic group and an organopolysiloxane having at least one acrylate group.

Aspect 31. The curable composition of any one of aspects 1-30 disposed on a substrate.

Aspect 32. A hardcoat prepared by subjecting the curable composition of any one of aspects 1-31 to a curing condition so as to prepare a hardcoat comprising constituents: a host matrix; a nanoporous filler in which the dispersed phase is a gas; and nonporous nanoparticles having a maximum diameter less than 100 nanometers; wherein the nanoporous filler is disposed in the host matrix at a concentration of from 0.1 to 10 weight percent (wt %); and wherein the nonporous nanoparticles are dispersed in the host matrix at a concentration from 5 to 60 wt %, all based on total weight of the hardcoat; and optionally further comprising a modifier, when present in the curable composition, wherein the modifier has become covalently-bound to a portion of the hardcoat.

Aspect 33. A hardcoat comprising constituents: a host matrix; a nanoporous filler in which the dispersed phase is a gas; and nonporous nanoparticles having a maximum diameter less than 100 nanometers; wherein the nanoporous filler is disposed in the host matrix at a concentration of from 0.1 to 10 weight percent (wt %), based on total weight of the hardcoat; and wherein the nonporous nanoparticles are dispersed in the host matrix at a concentration from 5 to 60 wt %, based on total weight of the hardcoat. Alternatively, the concentration of the nanoporous filler may be from 0.5 to 5 wt %, alternatively from 1 to 3 wt %, alternatively from 1.6 to 2.4 wt %, alternatively 2±0.3 wt %, all based on total weight of the hardcoat. Alternatively, the concentration of the nonporous nanoparticles may be from 10 to 55 wt %, alternatively from 20 to 50 wt %, alternatively from 30 to 39 wt %, alternatively 35±3 wt %, all based on total weight of the hardcoat. The porosity or apparent porosity may be measured according to ASTM D1993-03(2013). Alternatively, the porosity of the nonporous particles may be from 0% to 5%, alternatively from 0% to 1%, alternatively from >0% to 10%, alternatively from >0% to 5%, alternatively from >0% to 1%, alternatively 0%.

Aspect 34. The hardcoat of aspect 33 wherein the nanoporous filler is an aerogel, a metal-organic framework, a zeolite, or a combination of any two or more thereof, wherein the aerogel, metal-organic framework or zeolite comprises particles, which are dispersed in the host matrix of the hardcoat.

Aspect 35. The hardcoat of aspect 34 wherein the nanoporous filler is the metal-organic framework or zeolite.

Aspect 36. The hardcoat of aspect 34 wherein the nanoporous filler is the aerogel.

Aspect 37. The hardcoat of any one of aspects 33, 34, and 36 wherein the nanoporous filler is a silica aerogel and the silica aerogel comprises particles having a diameter of from 1 micrometer (μm) to 50 μm.

Aspect 38. The hardcoat of any one of aspects 32-37 wherein the nonporous nanoparticles are colloidal silica, fumed silica, or a combination of colloidal and fumed silicas.

Aspect 39. The hardcoat of aspect 38 wherein the nonporous nanoparticles are surface-treated colloidal silica, surface-treated fumed silica, or a combination thereof, wherein the surface treatment independently is performed by contacting corresponding untreated nonporous nanoparticles with an organoalkoxysilane having an aliphatic unsaturated bond to give the surface-treated nonporous nanoparticles.

Aspect 40. The hardcoat of any one of aspects 32-39 wherein the hardcoat is disposed on a substrate.

Aspect 41. The hardcoat of aspect 40 wherein the substrate is composed of a ceramic, a metal, or a polymer of the thermoplastic type or thermosetting type. The substrate may be composed of ceramic, alternatively a metal, alternatively a polymer of the thermoplastic type or thermosetting type, alternatively a polymer of the thermoplastic type, alternatively a polymer of the thermosetting type.

Aspect 42. The hardcoat of aspect 40 or 41 being a film having a thickness of from greater than 0 to 20 micrometers (μm) and the substrate is composed of a polycarbonate or a poly(methyl methacrylate).

Aspect 43. The hardcoat of any one of aspects 32-42 wherein the hardcoat is a product of curing a curable composition consisting essentially of (i.e., substantially free or free of a vehicle) the following mixture of constituents: a matrix precursor containing curable groups; the nanoporous filler; and the nonporous nanoparticles.

Aspect 44. The hardcoat of aspect 43 wherein the curable composition further consists essentially of a curing agent for the matrix precursor. The curing agent may be a curing initiator or a curing catalyst.

Aspect 45. The hardcoat of any one of aspects 43-44 wherein the mixture of the curable composition further consists essentially of a constituent: a modifier containing, per molecule, one or more functional groups useful for forming one or more covalent bonds to at least one of the aforementioned constituents such that the modifier would form a covalently-bound portion of the hardcoat, wherein the modifier is dispersed in the mixture and wherein the amount of the modifier in the curable composition is from 0.05 to 5 wt %, based on total weight of the curable composition. Alternatively, the concentration of the modifier may be from 0.1 to 2 wt %, alternatively from 0.1 to 1 wt %, alternatively from 0.2 to 0.8 wt %, alternatively 0.4±0.1 wt %, all based on total weight of the curable composition, alternatively the hardcoat.

Aspect 46. A coating composition useful for coating a substrate, the coating composition comprising the constituents of the curable composition of any one of aspects 1-30 and a vehicle, wherein the constituents of the curable composition are dispersed in the vehicle and the vehicle has a lower boiling point than boiling points of the other constituents of the coating composition.

Aspect 47. The coating composition of aspect 46 further comprising water. The water may be used as a vehicle for the nonporous particles in embodiments wherein the nonporous nanoparticles comprise colloidal silica or fumed silica. The water may be a purified water such as distilled water or deionized water.

Aspect 48. The coating composition of aspect 46 or 47 disposed on a substrate.

Aspect 49. A method of preparing the curable composition of any one of aspects 1-30, the method comprising a step of removing the vehicle from a coating composition comprising the constituents of the curable composition and a vehicle, wherein the constituents of the curable composition are dispersed in the vehicle and the vehicle has a lower boiling point than boiling points of the other constituents of the coating composition, to give the curable composition, wherein the curable composition is substantially free or free of the vehicle.

Aspect 50. The method of aspect 49, the method comprising a step of applying the coating composition to a substrate so as to form a layer of the coating composition on the substrate, and then performing the removing step, which comprises removing the vehicle from the layer of the coating composition to give a layer of the curable composition on the substrate, wherein the curable composition is substantially free or free of the vehicle.

Aspect 51. The method of aspect 49 or 50 further comprising a step of subjecting the curable composition to a curing condition so as to prepare a hardcoat. The entire portion of the curable composition may be cured, alternatively only a patterned portion of the curable composition may be cured. For example, a layer of the curable composition may be subjected to a selective curing condition through a photomask or heat mask so as to cure a patterned portion of the layer and leave a remaining portion of the layer uncured. The uncured portion may optionally be removed such as by dissolving in a solvent such as PGMEA, poly(ethylene glycol) methyl ether acetate.

Aspect 52. A method of preparing a hardcoat, the method comprising subjecting a curable composition of any one of aspects 1-30, to a curing condition so as to prepare a hardcoat comprising constituents: a host matrix; a nanoporous filler in which the dispersed phase is a gas; and nonporous nanoparticles having a maximum diameter less than 100 nanometers; wherein the nanoporous filler is disposed in the host matrix at a concentration of from 0.1 to 10 weight percent (wt %); and wherein the nonporous nanoparticles are dispersed in the host matrix at a concentration from 5 to 60 wt %, all based on total weight of the hardcoat; and optionally further comprising a modifier, when present in the curable composition, wherein the modifier has become covalently-bound to a portion of the hardcoat.

Aspect 53. The method of aspect 52 wherein the curable composition is disposed as a layer on a substrate and the hardcoat is formed as a layer on the substrate.

Aspect 54. The method of aspect 53 further comprising a preliminary step of preparing the layer of the curable composition on the substrate from a layer of a coating composition comprising a mixture of the curable composition and a vehicle disposed on the substrate, the method comprising removing the vehicle from the layer of the coating composition so as to form the layer of the curable composition on the substrate.

Aspect 55. The method of aspect 54 wherein the removing the vehicle comprises heating the layer of the coating composition so as to volatilize the vehicle, thereby removing the vehicle from the layer of the coating composition and forming the layer of the curable composition on the substrate.

Aspect 56. The method of any one of aspects 52-55 wherein the curable composition is an ultraviolet light and/or heat curable composition and wherein the curing condition comprises subjecting the curable composition to ultraviolet light or heat so as to cure the curable composition and thereby prepare the hardcoat.

Aspect 57. The method of any one of aspects 54-56 further comprising preparing the layer of the coating composition on the substrate, the method comprising a preliminary step of applying a coating composition comprising the mixture of the aforementioned constituents and a vehicle on the substrate so as to form the layer of the coating composition on the substrate.

Aspect 58. An article comprising the curable composition of any one of aspects 1-30 disposed on a substrate.

Aspect 59. An article comprising the hardcoat of any one of aspects 32 to 39 and 41 to 45 disposed on a substrate.

Aspect 60. An article comprising the coating composition of aspect 46 or 47 disposed on a substrate.

Aspect 61. Use of the hardcoat of any one of aspects 32 to 45 in an article in need of scratch or impact resistance.

The curable composition consists essentially of the matrix precursor; the nanoporous filler in which the dispersed phase is a gas; and the nonporous nanoparticles. The nanoporous filler in which the dispersed phase is a gas, or nanoporous filler for short, is utilized to provide increased hardness and scratch resistance to a hardcoat prepared from the curable composition compared to a hardcoat prepared from a comparative curable composition that consists essentially of the matrix precursor and the nonporous nanoparticles but lacks or is free of the nanoporous filler.

The nanoporous filler may be classified in various ways, including according to the composition or type of the material; its average pore size; its extent of continuity; its shape or unit dimension; its extent of treatment; or a combination of any two or more such classifications. The nanoporous filler may be classified according to its composition or type of the material as being an aerogel, a metal-organic framework (MOF), or a zeolite. The aerogel may be a silica aerogel, a carbon aerogel, an organic polymer aerogel, or a metal oxide aerogel.

Alternatively or additionally, the nanoporous filler may be classified according to its extent of treatment as being an untreated material or a treated material. The untreated material may be used as obtained from a process of making same. The treated material may be prepared by contacting the untreated material with a treating agent as described later.

Alternatively or additionally, the nanoporous filler may be classified according to its extent of continuity as being continuous or discontinuous. The continuous nanoporous filler may be a three-dimensional framework, such as a single slab of aerogel. The discontinuous nanoporous filler may be a plurality of particles, such as a plurality of aerogel particles. The plurality of aerogel particles may be made by grinding or milling a slab of aerogel.

Alternatively or additionally, the nanoporous filler may be classified according to its shape or unit dimension as being irregularly shaped or regularly shaped. Irregularly shaped nanoporous filler may be randomly-shaped, such as particles from grinding or milling. Regularly shaped nanoporous filler may be a slab, spherical, cubic, ovoid, needle-like, rhomboid, etc. The irregular or regular shape may have a unit dimension suitable for characterizing the shape. The unit dimension may be, for example, length, width and height for slabs and cubes and maximum diameters for spheres and irregularly shaped particles, such as for a plurality of mesoporous aerogel particles.

Alternatively or additionally, as described earlier, the nanoporous filler may be classified according to its average pore size as being a macroporous material, a mesoporous material, a microporous material, or a blend of any two or more of the macroporous material, microporous material and mesoporous material. The blend may be a blend of macroporous material and mesoporous material; alternatively a blend of mesoporous material and microporous material; alternatively a blend of macroporous material and microporous material; alternatively a blend of a macroporous material, a mesoporous material, and a microporous material. The blend of any two or more of the macroporous material, mesoporous material, and microporous material is different than a single material having a range of pore sizes in at least two of the macropore regime, mesopore regime, and micropore regime. The latter single material will be a plurality of particles or a single framework all characterizable by an average pore size that falls within only one of the foregoing regimes. In contrast, the blend is composed of at least two different frameworks or at least two different types of particles, of the same or different composition, wherein each of the two different frameworks or at least two different types of particles is separately characterizable by average pore sizes in different ones of the foregoing regimes.

The nanoporous filler may be classified according to its average pore size as having an average pore size of from 2 nm to 99 nm, alternatively from 2 nm to 50 nm, alternatively from >50 nm to 99 nm, alternatively from 5 nm to 50 nm, alternatively from 10 nm to 90 nm, alternatively from 20 nm to 80 nm, alternatively from 20 nm to 40 nm. By adjusting manufacturing process conditions (e.g., as in a sol-gel process), the average pore size of the nanoporous filler may be controlled during its manufacture so as to fall within any one of the foregoing average pore size ranges. Conditions such as the precursors and catalyst used, the type of drying method used (e.g., supercritical drying or freeze-drying) and the rate of solvent removal during the drying step will control average pore size of a nanoporous filler made thereby.

Average diameter of pores, also referred to as volume average pore size or average pore size, is determined by a suitable gas adsorption method such as the BET is described by Sing K. S. W., et al., REPORTING PHYSISORPTION DATA FOR GAS/SOLID SYSTEMS with Special Reference to the Determination of Surface Area and Porosity, Pure and Applied Chemistry, 1985; vol. 57, no. 4, pages 603-619 (IUPAC). The measurement produces a pore size distribution and calculates a cumulative distribution cure, wherein the average pore size (average pore diameter) is equal to the pore size value indicated where the cumulative distribution curve is at 50%.

The nanoporous filler generally comprises, consists essentially of, or consists of particles of any material having pores with diameters of less than 100 nanometers (nm). The nanoporous filler may substantially lack or be free of pores having a diameter of greater than 100 nm. Each particle has a solid continuous phase that defines the pores and a dispersed gas phase that occupies the pores. The gas may be any gaseous or vaporous material such as air, water vapor, or a gas of molecular hydrogen, molecular nitrogen, a nitrogen oxide, molecular oxygen, ozone, carbon monoxide, carbon dioxide, argon, helium, methane, and the like. Typically, the gas is air or an inert gas such as molecular nitrogen or argon.

The nanoporous filler may be untreated, alternatively the nanoporous filler may be treated by contacting an untreated nanoporous filler with a filler treating agent, and allowing the resulting mixture to cure to give the treated nanoporous filler, as described later. The treatment may render the surface of the treated nanoporous filler hydrophobic. The treatment may be at the exterior surface, at the interior surface, or at both the exterior surface and interior surface (internal) of the nanoporous filler. If a starting material used to prepare the nanoporous filler has been pretreated, then the nanoporous filler prepared therefrom may be a treated nanoporous filler. If the material used to prepare the nanoporous filler is untreated, then the nanoporous filler prepared therefrom is an untreated nanoporous filler. The untreated nanoporous filler may subsequently be treated so as to prepare a treated nanoporous filler. The treated nanoporous filler prepared from a pretreated starting material and the treated nanoporous filler prepared from the untreated nanoporous filler may be different in terms of the extent of surface treatment.

The nanoporous filler may be an aerogel, a metal-organic framework, a zeolite, or a combination of any two or more of the foregoing materials. The combination may be two or more aerogels; an aerogel and a zeolite; or an aerogel, MOF, and a zeolite. The nanoporous filler may be an aerogel, MOF, or zeolite; alternatively an aerogel or MOF; alternatively an aerogel or zeolite; alternatively a MOF or zeolite; alternatively an aerogel, alternatively a MOF, alternatively a zeolite. For present purposes, the dispersed phase in the aerogel, metal-organic framework, zeolite, or a combination thereof is a gas. The gas may be as described above.

For example, the nanoporous filler may comprise or consist of a plurality of microporous particles. In some such aspects the microporous particles are MOF particles. In still other aspects the microporous particles are zeolite particles. In still other aspects the microporous particles are a blend of MOF particles and zeolite particles. Such microporous particles may be obtained from commercial suppliers or may be made by well-known methods.

Alternatively, the nanoporous filler may comprise or consist of a plurality of macroporous particles. In some such still other aspects the macroporous particles are macroporous oxide particles such as titanium dioxide particles, zirconium dioxide particles, or silicon dioxide particles. Such macroporous particles may be prepared by using droplets of a non-aqueous emulsion using the sol-gel process of A. Imhof and D. J. Pine, Macroporous Materials With Uniform Pores by Emulsion Templating, Mat. Res. Soc. Symp. Proc. 1998, vol. 497, pages 167-172 (Materials Research Society).

Alternatively, the nanoporous filler may comprise or consist of a plurality of mesoporous particles. In some such aspects mesoporous particles are aerogel particles, alternatively silica aerogel particles. Such mesoporous particles may be obtained from commercial suppliers or may be made by well-known methods.

For example, the nanoporous filler may be an aerogel. The dispersed phase in an aerogel is a gas. The nanoporous solid of the aerogel may be silica-based, carbon (e.g., a graphene aerogel), or a metal oxide. The aerogel may be prepared by any aerogel-preparing technique such as pyrolysis or supercritical drying of an aerogel-preparing material. Suitable aerogel-preparing materials include silica (use supercritical drying) and non-silica materials that include alumina; a metal oxide such as tungstic oxide, ferric oxide, or stannic oxide; and an organic material such as cellulose, nitrocellulose, or agar.

Typically, the nanoporous filler comprises a silica aerogel. The silica aerogel may be untreated (unmodified), alternatively the silica aerogel may be a treated silica aerogel. The treated silica aerogel may be prepared by contacting an untreated silica aerogel with a filler treating agent, and allowing the resulting mixture to cure to give the treated silica aerogel, as described later. The treatment may render the silica aerogel hydrophobic. The unmodified silica aerogel may have a hydrophilic exterior and interior and the treated silica aerogel may have a hydrophobic exterior and interior.

The silica aerogel particles of the nanoporous filler typically have an average particle size greater than 0 (e.g., 0.1) and less than 200 nanometers (nm), e.g. from 1 to 100, alternatively from 1 to 50, nanometers (nm). Examples of commercially available silica aerogels are a silica aerogel sold as Dow Corning® VM-2270 Aerogel Fine Particles (INCI name Silica Silylate) (described later; Dow Corning Corporation, Midland, Mich., USA) and a silica aerogel sold as Lumira® Translucent Aerogel LA1000, 2000 sold by Cabot Corporation, Belerica, Mass., USA. The Cabot aerogel has a particle size range from 0.7 to 4.0 millimeters (mm), a pore diameter of 20 nanometers (nm), a porosity >90%, a particle density from 120 to 150 kilograms per cubic meter (kg/m³), a bulk density from 65 to 85 kg/m³, hydrophobic surface chemistry, a surface area of 600 to 800 square meters per gram (m²/g), light transmission of >90% per centimeter (cm), and thermal conductivity of 18 mW/mK at 85 kg/m³ at 12.5° C.

The silica aerogel may be prepared from silica. The silica used to prepare the silica aerogel may be any type of silica, e.g. the silica may be fumed silica, precipitated silica, colloidal silica, etc. Typically, the silica used to prepare the silica aerogel is colloidal or fumed silica, alternatively colloidal silica, alternatively fumed silica. Once prepared, the silica aerogel may be mechanically pulverized to obtain particles thereof. The silica used to prepare the silica aerogel may be untreated, alternatively pretreated prior to being used to prepare the silica aerogel. The pretreatment may render the silica hydrophobic. If the silica used to prepare the silica aerogel is pretreated, then the silica aerogel prepared therefrom may be a treated silica aerogel. If the silica used to prepare the silica aerogel is untreated, then the silica aerogel prepared therefrom is an untreated silica aerogel. The untreated silica aerogel may subsequently be treated so as to prepare a treated silica aerogel.

The silica aerogel particles of the nanoporous filler may be pure silicon dioxide, or may comprise a nominal amount (a concentration of <1 wt %) of impurities, such as Al₂O₃, ZnO, and/or cations such as Na+, K+, Ca++, Mg++, etc.

The nanoporous filler may be combined in neat form with one or more of the other ingredients of the curable composition such as by mixing. Alternatively, the nanoporous filler may be suspended in a vehicle to prepare a suspension or dispersion of nanoporous filler therein. The vehicle may alternatively be referred to as a dispersion medium. When the nanoporous filler consist essentially of particles having a size of from 1 nm to 1,000 nm, the suspension of nanoporous filler in the vehicle may be a colloidal suspension. The suspension or dispersion of nanoporous filler may be combined with one or more of the other ingredients of the curable composition to prepare the coating composition. The vehicle may be removed from the coating composition to give the curable composition, which is substantially free or free of the vehicle. The nanoporous filler may be suspended or dispersed in the curable composition such as a colloidal dispersion.

The vehicle of the colloidal nanoporous filler typically has a moderately low boiling point temperature for removal of the vehicle from the coating composition without removing other constituents thereof. Removing the vehicle gives the curable composition. For example, the vehicle typically has a boiling point temperature at atmospheric pressure (i.e., 1 atm) of from 30 to 200, alternatively from 40 to 150, degrees Celsius (° C.).

Suitable vehicles for preparing the nanoporous filler suspension, and thus for preparing the colloidal nanoporous filler, and for that matter independently for preparing the coating composition, independently include polar and non-polar vehicles. Specific examples of such vehicles are water; alcohols, such as methanol, ethanol, isopropanol, n-butanol, and 2-methylpropanol; glycerol esters, such as glyceryl triacetate (triacetin), glyceryl tripropionate (tripropionin), and glyceryl tributyrate (tributyrin); polyalkylene glycols, such as polyethylene glycols and polypropylene glycols; alkyl cellosolves, such as methyl cellosolve, ethyl cellosolve and butyl cellosolve; dimethylacetamide; aromatics, such as toluene, xylene, and mesitylene; alkyl acetates, such as methyl acetate; ethyl acetate; butyl acetate; ketones, such as methyl isobutyl ketone and acetone; and carboxylic acids such as acetic acid. In specific embodiments, the vehicle of the nanoporous filler suspension is selected from water and an alcohol. The suspension of nanoporous filler in vehicle may alternatively be referred to as a colloidal nanoporous filler or as a nanoporous filler dispersion. Two or more different vehicles may be utilized, although such vehicles are generally compatible with one another such that the vehicle of the nanoporous filler dispersion is homogenous. The vehicle of the nanoporous filler dispersion is typically present therein at a concentration of from, for example, 10 to 70 weight percent based on the total weight of the nanoporous filler dispersion.

The curable composition also consists essentially of the nonporous nanoparticles having a maximum diameter less than 100 nm. The nonporous nanoparticles may comprise silica nanoparticles or other nonporous nanoparticle filler that is compatible with the host matrix and nanoporous filler. The silica nanoparticles may be colloidal silica, fumed silica, or a combination of colloidal and fumed silicas. As for the nanoporous filler, the nonporous nanoparticles may be untreated, alternatively treated. The treated nonporous nanoparticles may be surface-treated colloidal silica, surface-treated fumed silica, or a combination thereof, wherein the surface treatment independently is performed by contacting the corresponding untreated nonporous nanoparticles with an organoalkoxysilane having an aliphatic unsaturated bond, and allowing the resulting mixture to cure to give the surface-treated nonporous nanoparticles.

As mentioned, the nanoporous filler and nonporous nanoparticles independently may optionally be surface treated, e.g. with a filler treating agent. The nanoporous filler and/or nonporous nanoparticles independently may be surface treated prior to incorporation into the matrix precursor of the curable composition and/or vehicle of the coating composition, or they may be surface treated in situ.

The amount of the filler treating agent utilized to treat the nanoporous filler and/or nonporous nanoparticles may vary depending on various factors, such as the extent of surface area to be treated, the amount or concentration of functional groups on the (nano)particles available to react with the filler treating agent, and whether the nanoporous filler and/or nonporous nanoparticles is treated with the filler treating agent in situ or pretreated before being incorporated into the curable composition.

The filler treating agent may comprise a silane, such as an alkoxysilane; an alkoxy-functional oligosiloxane; a cyclic polyorganosiloxane; a hydroxyl-functional oligosiloxane, such as a dimethyl siloxane; methyl phenyl siloxane; a stearate; or a fatty acid. These filler treating agents are suitable for treating nanoporous filler or nonporous nanoparticles that are silica-based, particles that are not silica based, and combinations thereof.

Alkoxysilanes suitable for the filler treating agent are exemplified by hexyltrimethoxysilane, octyltriethoxysilane, decyltrimethoxysilane, dodecyltrimethoxysilane, tetradecyltrimethoxysilane, phenyltrimethoxysilane, phenylethyltrimethoxysilane, octadecyltrimethoxysilane, octadecyltriethoxysilane, and a combination thereof.

Alternatively, the alkoxysilane suitable for the filler treating agent may include an ethylenically unsaturated group. The ethylenically unsaturated group may comprise a carbon-carbon double bond, a carbon-carbon triple bond, or combinations thereof. In these embodiments, the alkoxysilane may be represented by general formula R²_{d1} ASi(OR³)_{3-d1}. In this general formula, R² is a substituted or unsubstituted monovalent hydrocarbon group which contains no aliphatic unsaturated bond. Specific examples thereof include alkyl groups, aryl groups, and fluoroalkyl groups. R³ is an alkyl group, typically having from 1 to 10 carbon atoms. Group A is a monovalent organic group having an aliphatic unsaturated bond. Specific examples of group A include acryl group-containing organic groups, such as a methacryloxy group, an acryloxy group, a 3-(methacryloxy)propyl group and a 3-(acryloxy)propyl group; alkenyl groups, such as a vinyl group, a hexenyl group and an allyl group; a styryl group and a vinyl ether group. Subscript d1 is 0 or 1. Specific examples of the alkoxysilane having an ethylenically unsaturated group include 3-(methacryloxy)propyltrimethoxysilane, 3-(methacryloxy)propyltriethoxysilane, 3-(methacryloxy) propylmethyldimethoxysilane, 3-(acryloxy)propyltrimethoxysilane, vinyltrimethoxysi lane, vinyltriethoxysilane, methylvinyldimethoxysilane and allyltriethoxysilane.

Alkoxy-functional oligosiloxanes may alternatively be used as the filler treating agent. Alkoxy-functional oligosiloxanes and methods for their preparation are known in the art. For example, suitable alkoxy-functional oligosiloxanes include those of the formula (R⁴O)ₑ₁Si(OSiR⁴₂R⁵)₍₄₋ₑ₁₎. In this formula, subscript el is 1, 2, or 3, alternatively 3. Each R⁴ is independently selected from saturated and unsaturated hydrocarbyl groups having from 1 to 10 carbon atoms. Each R⁵ is a saturated or unsaturated hydrocarbyl group.

Alternatively, silazanes may be utilized as the filler treating agent, either discretely or in combination with, for example, alkoxysilanes.

Alternatively still, the filler treating agent may an organosilicon compound. Examples of organosilicon compounds include, but are not limited to, organochlorosilanes such as methyltrichlorosilane, dimethyldichlorosilane, and trimethyl monochlorosilane; organosiloxanes such as hydroxy-endblocked dimethylsiloxane oligomer, hexamethyldisiloxane, and tetramethyldivinyldisiloxane; organosilazanes such as hexamethyldisilazane and hexamethylcyclotrisilazane; and organoalkoxysilanes such as methyltrimethoxysilane, vinyltrimethoxysilane, vinyltriethoxysilane, 3-glycidoxypropyltrimethoxysilane, and 3-methacryloxypropyltrimethoxysilane. Examples of stearates include calcium stearate. Examples of fatty acids include stearic acid, oleic acid, palmitic acid, tallow, coconut oil, and combinations thereof.

A residual amount of the filler treating agent may be present in the coating and/or curable composition, e.g. as a discrete constituent separate from the nanoporous filler and nonporous nanoparticles. When present, the residual amount may be less than 1 wt % of the coating and/or curable composition. The residual amount may, alternatively may not be removed from the coating and/or curable composition before the composition is used to prepare the hardcoat.

Alternatively, the particles of the nanoporous filler and/or nonporous nanoparticles need not be surface treated with the treating agent. In these embodiments, the nanoporous filler and/or nonporous nanoparticles may be respectively referred to as an unmodified nanoporous filler and/or unmodified nanoporous nanoparticles. The unmodified nanoporous filler and/or unmodified nonporous nanoparticles is/are typically in the form of an acidic or basic dispersion.

The curable composition also consists essentially of the matrix precursor. The matrix precursor may be composed of any material suitable for preparing a host matrix for the nanoporous filler and nonporous nanoparticles. For example, the matrix precursor may comprise a sol-gel, a polyfunctional isocyanate, a polyfunctional acrylate, or a polyfunctional curable organosiloxane. The matrix precursor may also comprise a combination of any two or more of the sol-gel, polyfunctional isocyanate, polyfunctional acrylate, and polyfunctional curable organosiloxane.

The matrix precursor may comprise a polyfunctional acrylate, which is a compound that has two or more acrylate functional groups per molecule. In certain embodiments, the polyfunctional acrylate has at least 3, alternatively at least 4, alternatively at least 5, alternatively at least 6, alternatively at least 7, alternatively at least 8, alternatively at least 9, alternatively at least 10, acrylate functional groups. Higher numbers of acrylate functional groups may also be suitable, e.g. an icosafunctional acrylate. The polyfunctional acrylate may be monomeric, oligomeric, a prepolymer, or polymeric in nature, and may comprise combinations thereof. For example, the polyfunctional acrylate may comprise a combination of a monomeric polyfunctional acrylate and an oligomeric polyfunctional acrylate. The polyfunctional acrylate may be linear, branched, or a combination of linear and branched polyfunctional acrylates.

The polyfunctional acrylate may be organic or silicone-based. When the polyfunctional acrylate is organic, the polyfunctional acrylate comprises a carbon-based backbone or chain, optionally with heteroatoms, such as O, therein. Alternatively, when the polyfunctional acrylate is silicone-based, the polyfunctional acrylate comprises a siloxane-based backbone or a chain comprising silicon-oxygen bonds. The polyfunctional acrylate may be a hybrid polyfunctional acrylate that comprises both carbon-based bonds and silicon-oxygen bonds, such as if the polyfunctional acrylate is prepared via hydrosilylation, in which case the hybrid polyfunctional acrylate is still referred to as being silicone-based due to the presence of silicon-oxygen bonds therein. In certain embodiments, when the polyfunctional acrylate is organic, the polyfunctional acrylate is free from any silicon-oxygen bonds, alternatively free from any silicon atoms. Typically, the polyfunctional acrylate is organic.

Specific examples of polyfunctional acrylates suitable for the present purposes include: difunctional acrylate monomers, such as 1,6-hexanediol diacrylate, 1,4-butanediol diacrylate, ethylene glycol diacrylate, diethylene glycol diacrylate, tetraethylene glycol diacrylate, tripropylene glycol diacrylate, neopentyl glycol diacrylate, 1,4-butanediol dimethacrylate, poly(butanediol) diacrylate, tetraethylene glycol dimethacrylate, 1,3-butylene glycol diacrylate, triethylene glycol diacrylate, triisopropylene glycol diacrylate, polyethylene glycol diacrylate and bisphenol A dimethacrylate; trifunctional acrylate monomers, such as trimethylolpropane triacrylate, trimethylolpropane trimethacrylate, pentaerythritol monohydroxytriacrylate and trimethylolpropane triethoxytriacrylate; tetrafunctional acrylate monomers, such as pentaerythritol tetraacrylate and ditrimethylolpropane tetraacrylate; penta-functional or higher polyfunctional monomers, such as dipentaerythritol hexaacrylate and dipentaerythritol (monohydroxy)pentaacrylate; bisphenol A epoxy diacrylate; hexafunctional aromatic urethane acrylate, aliphatic urethane diacrylate, and an acrylate oligomer of tetrafunctional polyester acrylate.

The polyfunctional acrylate may comprise a single polyfunctional acrylate or any combination of two or more polyfunctional acrylates. In certain embodiments, the polyfunctional acrylate comprises a penta- or higher polyfunctional acrylate, such as any polyfunctional acrylate from a pentafunctional acrylate to an icosafunctional acrylate, which may improve curing of the curable composition. Improving curing may comprise increasing crosslink density, faster cure speed, increased hardness of the cured product, or a combination of any two or more thereof. For example, in certain embodiments, the polyfunctional acrylate comprises the penta- or higher polyfunctional acrylate in an amount of at least 30, alternatively at least 50, alternatively at least 75, alternatively at least 80, percent by weight based on the total weight of the polyfunctional acrylate. Typically, the polyfunctional acrylate comprises the penta- or higher polyfunctional acrylate in an amount of at most 90, alternatively at most 85 percent by weight based on the total weight of the polyfunctional acrylate. Typically, the polyfunctional acrylate is free from any fluorine atoms, such as in fluoro-substituted groups.

The curable composition may further consist essentially of a curing agent. The curing agent typically is used in a molar amount that is from >0 to <1 times the molar amount of the matrix precursor. For example, the molar amount of the curing agent may be from 0.0001 to 0.2 times, alternatively from 0.001 to 0.01 times, alternatively from 0.005 to 0.1 times the molar amount of the matrix precursor. The curing initiator may be an organic peroxide or a photopolymerization inhibitor, which is described herein. The curing catalyst may be a polymerization catalyst such as a hydrosilylation catalyst or an aluminum-based catalyst such as trimethyl aluminum for polymerizing a polyfunctional acrylate.

The curing agent may be a photopolymerization initiator. The photopolymerization initiator is most commonly utilized if the curable composition is to be cured via irradiation with electromagnetic radiation. The photopolymerization initiator may be selected from known compounds capable of generating a radical under irradiation with electromagnetic radiation, such as organic peroxides, carbonyl compounds, organic sulfur compounds and/or azo compounds.

Specific examples of suitable photopolymerization initiators include acetophenone, propiophenone, benzophenone, xanthol, fluoreine, benzaldehyde, anthraquinone, triphenylamine, 4-methylacetophenone, 3-pentylacetophenone, 4-methoxyacetophenone, 3-bromoacetophenone, 4-allylacetophenone, p-diacetylbenzene, 3-methoxybenzophenone, 4-methylbenzophenone, 4-chlorobenzophenone, 4,4-dimethoxybenzophenone, 4-chloro-4-benzylbenzophenone, 3-chloroxanthone, 3,9-dichloroxanthone, 3-chloro-8-nonylxanthone, benzoin, benzoin methyl ether, benzoin butyl ether, bis(4-dimethylaminophenyl)ketone, benzyl methoxy ketal, 2-chlorothioxanthone, diethylacetophenone, 1-hydroxycyclohexyl phenyl ketone, 2-methyl[4-(methylthio)phenyl]2-morpholino-1-propanone, 2,2-dimethoxy-2-phenylacetophenone, diethoxyacetophenone, and combinations thereof.

If utilized, the photopolymerization initiator is typically present in the curable composition in an amount of from 1 to 30, alternatively 1 to 20, parts by weight, based on 100 parts by weight of the polyfunctional acrylate.

Additional examples of additives that may be present in the curable composition include antioxidants; thickeners; surfactants, such as leveling agents, defoamers, sedimentation inhibitors, dispersing agents, antistatic agents and anti-fog additives; ultraviolet absorbers; colorants, such as various pigments and dyes; butylated hydroxytoluene (BHT); phenothiazine (PTZ); and combinations thereof.

The curable composition may further consist essentially of a modifier. The modifier is an additive that is used to alter certain properties of the hardcoat, such as the properties of increases resistance to stains, smudges, fingerprints, or the like of the hardcoat; increases scratch resistance of the hardcoat; and improves the “feel” of the hardcoat (the coefficient of friction is lowered). The modifier may be any such material capable of forming covalent bonds with the matrix precursor, the host matrix prepared therefrom, the nanoporous filler (treated or untreated), and/or the nonporous nanoparticles. Typically, the modifier forms covalent bonds at least with the matrix precursor. The covalent bonds typically form during curing of the curable composition to give the hardcoat. Typically the modifier contains at least one, alternatively at least two unsaturated aliphatic groups. The modifier may be a fluoro-substituted compound having at least one unsaturated aliphatic group; an organopolysiloxane having at least one acrylate group; or a combination of the fluoro-substituted compound and the organopolysiloxane. The curable composition may further consist essentially of the curing agent and the modifier.

The modifier may be a fluoro-substituted compound having an aliphatic unsaturated bond. As with the polyfunctional acrylate, the fluoro-substituted compound may be organic or silicone-based, as described above. The aliphatic unsaturated bond may be a carbon-carbon double bond (C═O) or a carbon-carbon triple bond (C═O), although the aliphatic unsaturated bond is typically a double bond. The fluoro-substituted compound may have one aliphatic unsaturated bond or two or more aliphatic unsaturated bonds. The aliphatic unsaturated bond may be located at any position within the fluoro-substituted compound, e.g. the aliphatic unsaturated bond may be terminal, pendant, or a part of a backbone of the fluoro-substituted compound. When the fluoro-substituted compound includes two or more aliphatic unsaturated bonds, each aliphatic unsaturated bond may be independently located in the fluoro-substituted compound, i.e., the fluoro-substituted compound may include pendant and terminal aliphatic unsaturated bonds, or other combinations of bond locations.

In certain embodiments, the fluoro-substituted compound: (i) is partially fluorinated; (ii) comprises a perfluoropolyether segment; or (iii) both (i) and (ii). By partially fluorinated, it means that the fluoro-substituted compound is not perfluorinated. For example, partially fluorinated encompasses mono-substitution, where there is only one fluoro-substituted group and that group contains one fluorine atom, and polyfluorination, where there is one fluoro-substituted group and that group contains two or more fluorine atoms or polyfluorination where there are two or more fluoro-substituted groups and those groups each contain at least one fluorine atom, with the proviso that partially fluorinated also encompasses at least one C-H group. When the fluoro-substituted compound is both (i) and (ii), the fluoro-substituted compound includes a substituent or group that is not perfluorinated such that although the fluoro-substituted compound comprises a perfluorinated segment, the fluoro-substituted compound as molecule is not perfluorinated, but rather polyfluorinated.

When the fluoro-substituted compound comprises the perfluoropolyether segment, specific examples of groups that may be present in the perfluoropolyether segment include —(CF₂)—, —(CF(CF₃)CF₂O)—, —(CF₂CF(CF₃)O)—, —(CF(CF₃)O)—, —(CF(CF₃)—CF₂)—, —(CF₂—CF(CF₃))—, and —(CF(CF₃))—. Such groups may be present in any order within the perfluoropolyether segment and may be in randomized or block form. Each group may independently be present two or more times in the perfluoropolyether segment. Generally, the perfluoropolyether segment is free from oxygen-oxygen bonds, with oxygen generally being present as a heteroatom between adjacent carbon atoms so as to form an ether linkage. The perfluoropolyether segment is typically terminal, in which case the perfluoropolyether segment may terminate with a CF₃ group.

In one specific embodiment when the fluoro-substituted compound comprises the perfluoropolyether segment, the perfluoropolyether segment comprises groups having the general formula (a1):

—(C₃F₆O)ₓ₁—(C₂F₄O)_{y1}—(CF₂)_{z1}-(a1);

wherein subscripts x1, y1, and z1 are each independently selected from 0 and an integer from 1 to 40, with the proviso that all three of x1, y1, and z1 are not simultaneously 0. If x1 and y1 are both 0, then z1 is an integer from 1 to 40 and at least one other perfluoroether group is present in the perfluoropolyether segment. The subscripts y1 and z1 may be 0 and x1 is selected from integers from 1 to 40, alternatively the subscripts x1 and y1 is 0 and z1 is selected from integers from 1 to 40; alternatively the subscripts x1 and z1 is 0 and y1 is selected from integers from 1 to 40. The subscript z1 may be 0 and x1 and y1 are each independently selected from integers from 1 to 40, alternatively the subscript y1 is 0 and x1 and z1 are each independently selected from integers from 1 to 40; alternatively the subscript x1 is 0 and y1 and z1 are each independently selected from integers from 1 to 40. Typically, x1, y1, and z1 are each independently selected from integers from 1 to 40. The groups represented by subscripts x1 and y1 may be independently branched or linear. For example, (C₃F₆O) may independently be represented by CF₂CF₂CF₂O, CF(CF₃)CF₂O or CF₂CF(CF₃)O.

In certain embodiments the fluoro-substituted compound is the compound of any one of the aforementioned formulas (1) and (4) to (6) described above in certain numbered aspects. These fluoro-substituted compounds are described in U.S. application Ser. No. 61/954,096 filed Mar. 17, 2014, (Docket no. DC11806PSP1), entitled Fluorinated Compound, Curable Composition Comprising Same, and Cured Product, which is hereby incorporated by reference herein in its entirety.

In certain embodiments, the fluoro-substituted compound comprises the reaction product of a reaction of: a triisocyanate and a mixture of a perfluoropolyether compound having an active hydrogen atom and a monomeric compound having an active hydrogen atom and a functional group other than the active hydrogen atom.

The triisocyanate may be prepared by, for example, trimerizing a diisocyanate. Examples of suitable diisocyanates include those having aliphatically bonded isocyanate groups, such as hexamethylene diisocyanate, isophorone diisocyanate, xylylene diisocyanate, hydrogenated xylylene diisocyanate and dicyclohexylmethane diisocyanate; and diisocyanates having aromatically bonded isocyanate groups, such as tolylene diisocyanate, diphenylmethane diisocyanate, polymethylenepolyphenyl polyisocyanate, tolidine diisocyanate and naphthalene diisocyanate.

Specific examples of the triisocyanate include the following:

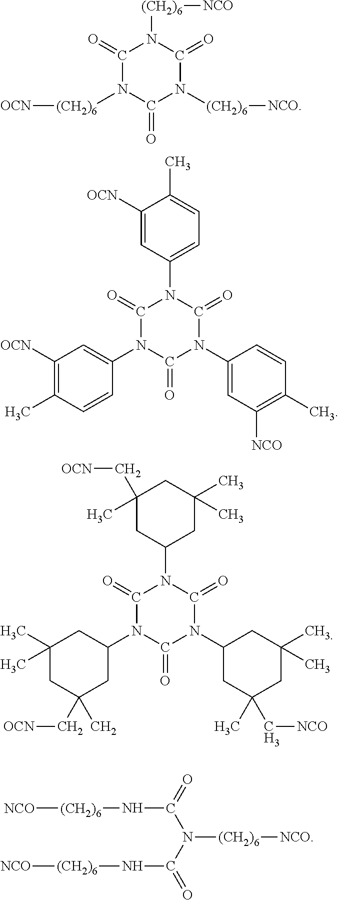

The perfluoropolyether compound and the monomeric compound each have an independently selected active hydrogen atom. These constituents may independently have two or more active hydrogen atoms. The heteroatom bearing the active hydrogen atom is capable of reacting with an isocyanato functional group of the triisocyanate. One of skill in the art readily understands such active hydrogen atoms and corresponding functional groups including these active hydrogen atoms that are reactive with isocyanate functional groups. In various embodiments, the active hydrogen atom of constituents perfluoropolyether compound and/or monomeric compound is covalently bonded with (or to) oxygen (O), nitrogen (N), phosphorus (P) or sulfur (S). In these embodiments, the active hydrogen atom of constituent monomeric compound is part of a reactive group. Examples of these reactive groups containing the active hydrogen include those comprising hydroxyl functionality (—OH), amino functionality (—NH₂), mercapto functionality (—SH), —NH—, and a phosphorus-hydrogen bond (—PH—). Such reactive groups may be substituents of the perfluoropolyether compound and/or monomeric compound or may be groups or portions of substituents or functionalities, as described below.

The perfluoropolyether compound generally comprises a perflurapolyether segment. The perfluoropolyether segment of the perfluoropolyether compound typically becomes the perfluoropolyether segment, if present, of the resulting fluoro-substituted compound prepared in part from the perfluoropolyether compound, as described below. The perfluoropolyether compound is typically linear. In certain embodiments, the perfluoropolyether compound has at least one terminal hydroxy group, alternatively two or more terminal hydroxyl groups. When the perfluoropolyether compound contains two or more terminal hydroxyl groups, the hydroxyl groups may be located at the same or opposite terminals of the perfluoropolyether compound. As described above, the terminal hydroxyl group may constitute the active hydrogen of the perfluoropolyether compound.

The perfluoropolyether compound typically has a number average molecular weight of from 200 to 500,000, alternatively from 500 to 10,000,000 grams per mole (g/mol).

In one specific embodiment, the perfluoropolyether compound has the following general formula:

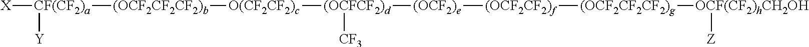

wherein X is F or a —CH₂OH group; Y and Z are each independently selected from F and —CF₃; a is an integer from 1 to 16; c is 0 or an integer from 1 to 5; b, d, e, f and g are each independently 0 or an integer from 1 to 200; and h is 0 or an integer from 1 to 16. In the general formula, X, Y, Z, and subscripts a to h are defined independently of those definitions used for formula (1) described earlier. In the general formula above, the groups or units represented by the various subscripts may be present in any order any may be in randomized or block form.

Specific examples of the perfluoropolyether compound include those disclosed in U.S. Pat. No. 6,906,115 B2, the disclosure of which is incorporated by reference herein in its entirety). In certain embodiments, the perfluoropolyether compound includes the perfluoropolyether segment, which has a number average molecular weight of from 1,000 to 100,000, alternatively from 1,500 to 10,000, g/mol.

As set forth above, the monomeric compound has a functional group other than and in addition to the active hydrogen atom. Typically, the functional group of the monomeric compound is a self-crosslinking functional group. Self-crosslinking functional groups are those that are capable of undergoing a crosslinking reaction with one another, even though the self-crosslinking functional groups are the same. Specific examples of self-crosslinking functional group include radical polymerization reactive functional groups, cationic polymerization reactive functional groups, and functional groups only capable of optical crosslinking. Examples of radical polymerization reactive functional groups that are self-crosslinking include functional groups containing ethylenic unsaturation (e.g. a double bond (C═C)). Examples of cationic polymerization reactive functional groups that are self-crosslinking include cationic polymerization reactive ethylenic unsaturation, epoxy groups, oxetanyl groups, and silicon compounds containing alkoxysilyl groups or silanol groups. Examples functional groups only capable of optical crosslinking include photodimerizable functional groups of vinylcinnamic acid.

In certain embodiments, the monomeric compound comprises a (meth)acrylate ester or vinyl monomer. In these embodiments, the monomeric compound may have from 2 to 30, alternatively from 3 to 20, carbon atoms.

Specific examples of the monomeric compound include hydroxyethyl (meth)acrylate; hydroxypropyl (meth)acrylate; hydroxybutyl (meth)acrylate; aminoethyl (meth)acrylate; HO(CH₂CH₂O)ᵢᵢ—COC(R⁶)C═CH₂ wherein R⁶ is selected from H and CH₃; and ii is an integer from 2 to 10); hydroxy-3-phenoxypropyl (meth)acrylate); allyl alcohol; HO(CH₂)ᵢᵢCH═CH₂ (where jj is an integer from 2 to 20); (CH₃)₃SiCH(OH)CH═CH₂; styryl phenol; and combinations thereof.

Additional aspects of this particular fluoro-substituted compound, including methods of its preparation, are disclosed in U.S. Pat. No. 8,609,742 B2, which is incorporated by reference herein in its entirety.

Alternatively or additionally, the modifier may comprise or further comprise the organopolysiloxane having at least one acrylate group. The organopolysiloxane may have two or more acrylate groups, e.g. from 2 to 20, alternatively from 2 to 10, acrylate groups. The acrylate groups may independently be terminal and/or pendant in the organopolysiloxane. The organopolysiloxane may be linear, branched, cyclic, alicyclic, etc. and may have any structure including silicon-oxygen and at least one acrylate group. The acrylate group may be bonded directly to a silicon atom of the organopolysiloxane, linked to a silicon atom of the organopolysiloxane via divalent linking group, bonded to an atom other than silicon in the organopolysiloxane (e.g. carbon), etc.

The organopolysiloxane typically includes silicon-bonded groups other than those including amino-substitution. Such silicon-bonded groups are generally monovalent and may be exemplified by alkyl groups, aryl groups, alkoxy groups, and/or hydroxyl groups. The organopolysiloxane typically has a degree of polymerization of from 2 to 1000, alternatively from 2 to 500, alternatively from 2 to 300.

The organopolysiloxane may be prepared from the Michael addition reaction between the amino-substituted organopolysiloxane and the polyfunctional acrylate. Alternatively, the organopolysiloxane may be prepared via other methods. For example, the organopolysiloxane may be prepared by reacting an organopolysiloxane having at least one silicon-bonded hydrogen atom with an alkenyl-functional methacrylate compound, in which case the organopolysiloxane is prepared via hydrosilylation. One such specific example of an organopolysiloxane having at least one acrylate group suitable for the organopolysiloxane is disclosed in U.S. application Ser. No. 61/954,096 filed Mar. 17, 2014, (Docket no. DC11806PSP1), entitled Fluorinated Compound, Curable Composition Comprising Same, and Cured Product, which has been previously incorporated by reference herein in its entirety.

If desired, an additional filler may be present in the curable composition, e.g. a filler other than, and in addition to, the nanoporous filler and nonporous nanoparticles. Examples thereof include alumina, calcium carbonate (e.g., fumed, fused, ground, and/or precipitated), diatomaceous earth, talc, zinc oxide, chopped fiber such as chopped KEVLAR®, onyx, beryllium oxide, zinc oxide, aluminum nitride, boron nitride, silicon carbide, tungsten carbide; and combinations thereof.

The constituents of the curable composition may optionally further comprise a vehicle comprising (i) water; (ii) a vehicle other than water; or (iii) (i) and (ii). When constituents of the curable composition further comprise the vehicle, the resulting composition is referred to herein as the coating composition. The vehicle is present in the coating composition in an amount sufficient to convey at least one of the other constituents thereof for purposes of mixing the constituents together or for applying the coating composition to a substrate, such as for forming a coating of the coating composition on the substrate.

When water is not used as a vehicle, water may still be present as a curing agent in the curable composition for hydrolysis of the nanoporous filler and/or nanoparticles. In such embodiments, the curable composition containing water as a curing agent is still referred to herein as a curable composition. For example, as known in the art, the colloidal or fumed silica particles may include silanol groups at a surface thereof. When water is utilized as the vehicle for the colloidal or fumed silica particles when mixing the particles with the other constituents of the coating or curable composition, a discrete amount of water as curing agent is not needed in the coating or curable compositions. Further, if the nanoporous filler and/or nanoparticles is/are already surface treated, water is not typically utilized when mixing the particles with the other constituents of the coating or curable composition or as a curing agent in the curable composition.

The vehicle for use in the coating composition is as described earlier for the fillers. The vehicle for the coating composition is typically an alcohol-containing vehicle. The alcohol-containing vehicle may comprise, consist essentially of, or consist of an alcohol. The alcohol-containing vehicle is for dispersing the constituents of the curable composition. In certain embodiments, the alcohol-containing vehicle solubilizes the constituents of the curable composition, in which case the alcohol-containing vehicle may be referred to as an alcohol-containing solvent.

Specific examples of alcohols suitable for the alcohol-containing vehicle include methanol, ethanol, isopropyl alcohol, butanol, isobutyl alcohol, ethylene glycol, diethylene glycol, triethylene glycol, ethylene glycol monomethyl ether, diethylene glycol monomethyl ether, triethylene glycol monomethyl ether, and combinations thereof. When the alcohol-containing vehicle comprises or consists essentially of the alcohol, the alcohol-containing vehicle may further comprise an additional organic vehicle. Specific examples thereof include acetone, methyl ethyl ketone, methyl isobutyl ketone, or similar ketones; toluene, xylene, mesitylene, or similar aromatic hydrocarbons; hexane, octane, heptane, or similar aliphatic hydrocarbons; chloroform, methylene chloride, trichloroethylene, carbon tetrachloride, or similar organic chlorine-containing solvents; ethyl acetate, butyl acetate, isobutyl acetate, or a similar fatty acid ester. When the alcohol-containing vehicle comprises the additional organic vehicle, the alcohol-containing vehicle typically comprises the alcohol in an amount of from 10 to 90, alternatively from 30 to 70, weight percent based on the total weight of the alcohol-containing vehicle, with the balance of the alcohol-containing vehicle being the additional organic vehicle.

The curable and coating compositions independently may be prepared via various preparation methods involving the combination of the various constituents of the curable composition. In certain embodiments, the nanoporous filler is surface treated prior to incorporation into the curable and coating compositions. The constituents may individually or collectively be heated before, during, or after the preparation of the curable and coating compositions.

The curable and coating compositions independently may be utilized in a variety of end uses and applications. Most typically, the curable and coating compositions are utilized to prepare the hardcoat. The hardcoat may be in the form of a fiber, a coating, a layer, a film, a composite, an article such as a shaped article, etc.

The hardcoat may be prepared from the curable composition. The hardcoat includes a host matrix with the nanoporous filler and nonporous nanoparticles independently being dispersed in the host matrix. The host matrix may be prepared from a reaction of the polyfunctional acrylate and the modifier. The modifier may be the fluoro-substituted compound having an aliphatic unsaturated bond, and the organopolysiloxane having at least one acrylate group. The nanoporous filler and nonporous nanoparticles are generally homogenously dispersed in the host matrix of the hardcoat, although one or both of the nanoporous filler and nonporous nanoparticles independently may be heterogeneously dispersed in the host matrix or otherwise in varying concentrations across any dimension of the hardcoat.

The host matrix of the hardcoat may comprise or consist of a three dimensional structure composed of at least one polymer backbone portion and one or more crosslinking segments, which are covalently bonded at different locations on the backbone. The host matrix material may be characterized by its crosslink density or number of crosslinks therein, its chemical composition such as types of atoms (e.g., with or without Si atoms), empirical formula, number average molecular weight (Mₙ), weight average molecular weight (M_{w}), degree of polymerization (DP), the structural nature of the polymer backbone (e.g., Si—O—Si type or organic type such as an all-carbon backbone or an organoheterylene backbone such as a polyester, polyamide, polycarbonate, and the like), the pendant functional groups bonded to the backbone, the terminal functional groups bonded to the backbone, the structural nature of the crosslink segments, the length of the crosslink segments, the type of functional group in which the covalent bonds between the crosslink segments and backbone are found, whether or not the crosslink segments are bonded to the nanoporous filler and/or the nonporous nanoparticles, whether or not the polymer backbone is bonded to the nanoporous filler and/or the nonporous nanoparticles, or a combination of any two or more thereof.

Each of the coating and curable compositions independently may be applied on the substrate to any thickness to provide, after curing, a hardcoat having at least one, alternatively a combination of any two or more desirable properties. Examples of these properties are: (a) a desired amount or degree of hardness (e.g., scratch or impact resistance), (b) a desired amount or degree of stain or smudge resistance (e.g., oil, stain, and/or soil repellency), (c) a desired amount or degree of water repellency (e.g., as a desired degree of water contact angle), or (d) a combination of at least two of (a), (b), and (c). Typically, the hardcoat has the combination of at least two of (a) to (c), e.g., (a) and (b); alternatively (a) and (c); alternatively (b) and (c); alternatively (a), (b), and (c). The curable and coating compositions and the hardcoat may be characterized by test methods that include anti-abrasion test, coefficient of friction (COF) test, contact angle tests, contact angle durability test, cross hatch adhesion test, haze, pencil hardness test, stain marker test, and transmittance test. Some of these test methods are described later.

For example, the hardcoat has excellent physical properties and is suitable for use as protective coatings on a variety of substrates. For example, the hardcoat has excellent (i.e., high) hardness, durability, adhesion to the substrate, and resistance to staining, smudging, and scratching. In certain embodiments, the hardcoat has a water contact angle of at least 90, alternatively at least 100, alternatively at least 105, alternatively at least 108, alternatively at least 110, degrees (°). In these embodiments, the upper limit is typically 120°. The water contact angle of the hardcoat is typically within this range even after subjecting the hardcoat to an abrasion test, which illustrates the excellent durability of the hardcoat. For example, for hardcoats having a lesser durability, the water contact angle decreases after abrasion, which generally indicates that the hardcoat has at least partially deteriorated.

In these embodiments, the hardcoat also typically has a sliding (kinetic) coefficient of friction (μ) of from greater than 0 to less than 0.2, alternatively from greater than 0 to less than 0.15, alternatively from greater than 0 to less than 0.125, alternatively from greater than 0 to less than 0.10. Although coefficient of friction is unitless, it is often represented by (μ).

For example, sliding (kinetic) coefficient of friction may be measured by disposing an object having a determined surface area and mass onto the hardcoat with a select material (e.g. a standard piece of legal paper) between the object and the hardcoat. A force is then applied perpendicular to gravitational force to slide the object across the hardcoat for a predetermined distance, which allows for a calculation of the sliding coefficient of friction of the hardcoat.

The invention additionally provides a method of preparing the hardcoat with the curable or coating composition. The method of preparing the hardcoat comprises curing the curable composition so as to prepare the hardcoat. The method of preparing the hardcoat may further comprise a preliminary step of preparing the curable or coating composition. This preliminary step may be carried out as described earlier herein.

Typically, the hardcoat is prepared on a substrate. The curable composition may be cured on a substrate so as to prepare the hardcoat on the substrate. The method of preparing the hardcoat may further comprise a preliminary step of applying the curable composition to or on the substrate. Alternatively, the method of preparing the hardcoat may further comprise a preliminary step of applying the coating composition to or on the substrate. The curing step of the method of preparing the hardcoat may comprise subjecting the curable composition or coating composition, as the aspect may be, to a curing condition so as to cure the matrix precursor material, any modifier if present, and any optional constituent, if present, that may be in need of reacting and curable thereby, so as to prepare or prepare the hardcoat. When the method of preparing the hardcoat further comprises applying the coating composition to or on the substrate, the method may further comprise an optional preliminary step of removing the vehicle from the coating composition on the substrate to give the curable composition on the substrate. The removing step may be performed before or during the curing step. For example, the method of preparing the hardcoat may comprise applying the curable composition on the substrate to form a wet layer thereof on the substrate, and subjecting the wet layer on the substrate to a curing condition so as to cure the wet layer and prepare the hardcoat. Suitable curing conditions are described later.

The method by which the coating or curable composition is applied to or on the substrate may vary. For example, in certain embodiments, the step of applying the coating or curable composition on the substrate uses a wet coating application method. Specific examples of wet coating application methods suitable for the method include dip coating, spin coating, flow coating, spray coating, roll coating, gravure coating, sputtering, slot coating, and combinations thereof. The alcohol-containing vehicle, along with any other vehicles or solvents preset in the curable composition and wet layer, may be removed from the wet layer via heating or other known methods.

The surface of the substrate may be primed prior to applying the coating or curable composition. For example, a primed surface may be formed on the substrate by the application of a chemical primer layer, such as an acrylic layer, or from chemical etching, electronic beam irradiation, corona treatment, plasma etching, or co-extrusion of adhesion promoting layers. Many such primed substrates are commercially available.

In certain embodiments, the hardcoat may alternatively be referred to as a layer or film, although the hardcoat may have any shape or form other than that associated with layers or films. In these embodiments, the hardcoat has a thickness of from greater than 0 to 20, alternatively from greater than 0 to 10, alternatively from greater than 0 to 5, micrometers (μm). In certain embodiments, the hardcoat has a thickness of at least 15, alternatively at least 20, alternatively at least 30, Angstroms, with the upper limit in such embodiments being 20 μm. The curable and coating compositions and the hardcoat independently may comprise a film having a thickness of from greater than 0 to 20 μm.

The curable and/or coating composition(s), as well as the wet layer formed therefrom, can be rapidly cured by subjecting same to a suitable curing condition. Examples of suitable curing conditions include being irradiated with active-energy rays (i.e., high-energy rays). The active-energy rays may comprise ultraviolet rays, electron beams, or other electromagnetic waves or radiation. The use of ultraviolet rays is preferable from the point of view of low cost and high stability. A source of ultraviolet radiation may comprise a high-pressure mercury lamp, medium-pressure mercury lamp, Xe-Hg lamp, or a deep UV lamp.

The step of curing the wet layer of the curable and/or coating composition(s) generally comprises exposing the wet layer to radiation at a dosage sufficient to cure at least a portion, alternatively the entirety, of the wet layer. The dosage of radiation for curing the wet layer is typically from 10 to 8000 milliJoules per centimeter squared (mJ/cm²). In certain embodiments, heating is used in conjunction with irradiation for curing the wet layer. For example, the wet layer may be heated before, during, and/or after irradiating the wet layer with active-energy rays. While active energy-rays generally initiate curing of the curable and/or coating composition(s), residual amounts of the alcohol-containing vehicle or any other vehicles and/or solvents may be present in the wet layer, which may be volatilized and driven off by heating. Typical heating temperatures are in the range of from 50° to 200° C. Curing the wet layer provides the hardcoat.

The method may form the hardcoat, and the hardcoat may be formed in and have, any shape or configuration. The shape of the hardcoat may be regular or irregular, flat or contoured, patterned or smooth surfaced, two-dimensional (e.g., a rod) or three dimensional (e.g., a sphere, ovoid, box, etc.), and the like.

The hardcoat, and the curable and coating compositions used to prepare same, may be of any size or dimension. The hardcoat and compositions independently may have a largest dimension (e.g., diameter or length) of from 1 nm to 1,000 nm, from 1 micrometer (μm) to 1,000 μm, from 1 millimeter (mm) to 1 centimeter (cm), from 1 cm to 1 decimeter, from 1 decimeter to 1 meter, from 1 meter to 10 meters, from 10 meters to 100 meters, or from 100 meters to 1,000 meters, or longer. The hardcoat and compositions independently may have a smallest dimension (e.g., thickness) that independently is in any one of the foregoing ranges and smaller than the largest dimension thereof.

The hardcoat may be a free-standing article, alternatively the hardcoat may be disposed on a substrate so as to give an article comprising a hardcoat/substrate composite. The hardcoat may be prepared, formed, disposed or used on the substrate. The function of the substrate, relative to the hardcoat, is not limited and may be to physically support the hardcoat, to provide a shaped surface for the hardcoat, to transfer heat to or from the hardcoat, to transmit light to the hardcoat, or a combination of any two or more thereof. The substrate may have additional functions relative to the article that are independent of the functions it has relative to the hardcoat.

For example, the substrate may be composed of a cement, a stone material, paper, cardboard, a ceramic, a metal, or a polymer; alternatively a metal or a polymer; alternatively a metal; alternatively a polymer. The polymer may be of the thermoplastic type or thermosetting type, e.g., a polycarbonate or a poly(methyl methacrylate). The substrate may be composed of organic materials such as transparent plastic materials and transparent plastic materials comprising an inorganic layer, etc. may use the hardcoat for glossy appearance and other function. Specific examples of organic materials and/or polymeric articles include polyolefins (e.g. polyethylene, polypropylene, etc.), polycycloolefins, polyesters (e.g. polyethylene terephthalate, polyethylene naphthalate, etc.), polycarbonates, polyamides (e.g. nylon 6, nylon 66, etc.), polystyrene, polyvinyl chloride, polyimides, polyvinyl alcohol, ethylene vinyl alcohol, acrylics (e.g. polymethylmethacrylate), celluloses (e.g. triacetylcellulose, diacetylcellulose, cellophane, etc.), or copolymers of such organic polymers. For example, the substrate may be composed of a polycarbonate or a poly(methyl methacrylate).

These transparent materials may also be used as substrates in optical articles. Such materials include soda-lime glass, alkali-aluminosilicate glass (e.g., Gorilla Glass®, Corning Inc., Corning, N.Y., USA), polycarbonates, PMMA (polymethylmethacrylate), PET (polyethylene terephthalate), and ceramic substrates. An example of a polycarbonate substrate is Clear LEXAN Polycarbonate 9034 Sheeting with 1/16 inch (1.6 mm) thickness.

While the hardcoat may be used on any substrate or as a component in any article, typically the substrate or article is that which is in need of one or more of the hardcoat's functional properties. These functional properties include scratch resistance, impact resistance, water repellency, smudge or stain resistance, a glossy appearance, and easy-to-clean properties. The glossy appearance makes the substrate or article aesthetically pleasing.

The hardcoat may be used in any article in need of scratch resistance, impact resistance, water repellency, smudge or stain resistance, or easy-to-clean properties. Examples of suitable articles for use with the hardcoat and in need of the hardcoat's functional properties include consumer appliances and components, transportation vehicles and components, electrical articles, optical articles, opto-electrical articles, building components such as windows, and the like. Articles that benefit from the hardcoat and its functional properties include electronic articles, optical articles, opto-electronic articles, and articles that are not optical or electronic. Examples of suitable electronic articles typically include those having electronic displays, such as liquid crystal displays (LCDs), light-emitting diode (LED) displays, organic light-emitting diode (OLED) displays, plasma displays, etc. These electronic displays are often utilized in various electronic articles, such as computer monitors, televisions, smart phones, global positioning systems (GPS) units, music players, remote controls, hand-held video games, portable readers, automobile display panels, etc. For example, the substrate may comprise an electronic article, an optical article, consumer appliances and components, automotive bodies and components, polymeric articles, etc. Examples of consumer appliances and components are a dishwasher, stove, microwave oven, refrigerator, and freezer, etc. Examples of transportation vehicles and components are automotive body or component and airplane body or component. Examples of optical articles are antireflective films, optical filters, optical lenses, eyeglass lenses, beam splitters, prisms, mirrors, etc.

The substrate may comprise an antireflective coating. The antireflective coating may include one or more layers of material disposed on an underlying second substrate. The antireflective coating generally has a lesser refractive index than the underlying second substrate. The antireflective coating may be multi-layer. Multi-layer antireflective coatings include two or more layers of dielectric material on the underlying substrate, wherein at least one layer has a refractive index higher than the refractive index of the underlying substrate. Such multi-layer antireflective coatings are often referred to as antireflective film stacks.

The hardcoat may provide an anti-glare function to the article. The hardcoat also resists stains, such as dirt, etc., as well as smudges from fingerprints. These functional properties of the hardcoat may be measured using well known test methods including the test methods described below.

Anti-abrasion Test: The anti-abrasion test utilizes a reciprocating abraser—Model 5900, which is commercially available from Taber Industries of North Tonawanda, New York. The abrading material utilized is a CS-17 Wearaser® from Taber Industries. The abrading material has dimensions of 6.5 mm×12.2 mm. The reciprocating abraser is operated for 10, 25, and 100 cycles at a speed of 25 cycles per minute with a stroke length of 1 inch and a load of 10.0 N. Following each of the cycles, the surfaces of the hardcoats are visually inspected to determine abrasion. The following ratings are assigned based on this optical inspection:
Rating 1: no damage to the hardcoat;
Rating 2: minor scratches to the hardcoat;
Rating 3: moderate scratches to the hardcoat;
Rating 4: substrate is partially visible through the scratched hardcoat; and
Rating 5: substrate is fully visible through the scratched hardcoat.

Anti-Glare Rating: Hardcoat samples coated on transparent substrates such as polycarbonate or glass were placed on a set-up comprising a horizontally disposed computer screen and an overhead light placed directly above the computer screen. The ability to read the computer screen at about a 45° angle due to glare from the overhead light was then rated good, medium or poor as follows:

Anti-Glare Rating—Good: Ability to clearly read information on the computer monitor without glare from the overhead light (light from overhead light is well diffused);

Anti-Glare Rating—Medium: Partial ability to read information on the computer monitor with some loss in ability due to reflection of light from the overhead light; or

Anti-Glare Rating—Poor: No ability to read information on the computer monitor due to strong reflection of light from the overhead light (light from overhead light is poorly diffused).

Coefficient of Friction (COF) Test: The COF is measured via a TA-XT2 Texture Analyzer, commercially available from Texture Technologies of Scarsdale, N.Y. The COF is measured by placing a sled having a load of about 156 grams onto each of the hardcoats with a piece of standard paper disposed between each of the hardcoats and the sled. The sled has an area of about 25×25 millimeters. A force is applied in a direction perpendicular to gravity to move the sled along each of the layers at a speed of about 2.5 millimeters/sec for a distance of about 42 millimeters to measure the COF. Although COF is unitless, it is often represented by μ. The standard deviation of the COF is also included below.

Contact Angle Tests (water contact angle (WCA) and hexadecane contact angle (HCA)): The static contact angles of water and hexadecane on each of the hardcoats are evaluated. Specifically, the static contact angles of water and hexadecane are measured via a VCA Optima XE goniometer, which is commercially available from AST Products, Inc., Billerica, Mass. The water contact angle measured is a static contact angle based on a 2 μL droplet on each of the hardcoats. The contact angle of water is referred to as WCA (water contact angle), and the contact angle of hexadecane is referred to as HCA (hexadecane contact angle). The WCA and HCA values are degrees (°).

Contact Angle Durability Test: Durability of the hardcoats is measured via the contact angle durability test, which measures the WCA and HCA after abrasion of the hardcoats. Generally, the greater the WCA or HCA after abrasion, the more durable the hardcoat. The WCA and HCA are measured as described above after abrasion of the hardcoats. Abrasion of the hardcoats is carried out via the reciprocating abraser—Model 5900, which is commercially available from Taber Industries of North Tonawanda, N.Y. The abrading material utilized is a microfiber cloth (Wypall™, commercially available from Kimberly-Clark Worldwide, Inc. of Irving, Tex., USA) having an area of 2×2 centimeters (cm). The reciprocating abraser is operated 10,000 cycles at a speed of 60 cycles per minute with a load of 250 grams.

Cross Hatch Adhesion Test: The cross hatch adhesion test is performed in accordance with ASTM D 3002, entitled “Evaluation of Coatings Applied to Plastics” and ASTM D 3359-09e2, entitled “Standard Test Methods for Measuring Adhesion by Tape Test” utilizes right angle cuts (which are cross-hatched) in the hardcoats to the underlying substrates. The cracking of cutting edges and loss of adhesion is inspected based on the ASTM standard below:
ASTM class 5B: The cutting edges are completely smooth and none of the squares in the lattice formed from the cross hatch test are detached from the underlying substrate;
ASTM class 4B: Detachment of small flakes of the hardcoats at intersecting cuts; a cross cut area not significantly greater than 5% by area is affected;
ASTM Class 3B: The hardcoat has flaked along the cutting edges and at intersecting cuts; a cross cut area significantly greater than 5%, but not significantly greater than 15%, by area is affected;
ASTM class 2B: The hardcoat has flaked along the cutting edges partly or wholly in large ribbons, and/or has flaked partly or wholly on different squares in the lattice formed from the cross hatch test; a cross cut area significantly greater than 15%, but not significantly greater than 35%, by area is affected;
ASTM class 1 B: The hardcoat has flaked along the cutting edges in large ribbons and/or some squares in the lattice formed from the cross hatch test have detached partly or wholly from the underlying substrate; a cross cut area significantly greater than 35%, but not significantly greater than 65%, by area is affected;
ASTM Class OB: Any degree of flaking that cannot be classified as ASTM class 1 B-5B.

Elongation at break (%): measured in accordance with ASTM D522-93a (Reapproved in 2008) (Standard Test Methods for Mandrel Bend Test of Attached Organic Coatings).

Haze Test: Measured sample haziness using a BYK Haze-Gard Plus transparency meter in accordance with ASTM D1003-13 (Standard Test Method for Haze and Luminous Transmittance of Transparent Plastics).

Mandrel Bend Test: measured in accordance with ASTM D522-93a (Reapproved 2008) (Standard Test Methods for Mandrel Bend Test of Attached Organic Coatings).

Pencil Hardness Test: The pencil hardness of each of the hardcoats is measured in accordance with ASTM D3363-05(2011)e2, entitled “Standard Test Method for Film Hardness by Pencil Test.” Pencil hardness values are generally based on graphite grading scales, which range from 9H (hardest value) to 9B (softest value).

Stain Marker Test: The stain marker tests measures optically the ability of the hardcoats to exhibit stain resistance. In particular, in the stain marker test, a line is drawn on each of the hardcoats with a Super Sharpie® permanent marker (commercially available from Newell Rubbermaid Office Products of Oak Brook, Ill.). The lines are inspected optically to determine whether the lines beaded on the hardcoats. A “1” ranking indicates that the line fully beads into a small droplet, whereas a “5” ranking indicates that the line does not bead whatsoever. Thirty seconds after drawing each line on the hardcoats, the line is wiped with a piece of paper (Kimtech Science™ Kimwipes™, commercially available from Kimberly-Clark Worldwide, Inc. of Irving, Tex., USA) five consecutive times. A “1” ranking indicates that the line (or beaded portion thereof) is fully removed from the substrate, whereas a “5” ranking indicates that the line is not removed whatsoever.

Transmittance Test: transmittance was measured using 5000 UV-Vis-NIR Spectrophotometer manufactured by Varian Cary

Polycarbonate (PC) Substrate: polycarbonate sheets used were 1/16 inch (1.6 mm) thick sheets manufactured by Sabic as LEXAN 9034. The PC sheets were precut to a 3-inch-by-3-inch (7.62-cm-by-7.62-cm) square. Prior to coating, the sheets were cleaned by washing them in an ultrasonic bath (Fisher Scientific FS220) first in detergent for 3 minutes, followed by 3 washes in deionized (DI) water for 3 minutes each, and the resulting washed sheets were air dried.

Glass Substrates: silicate glass sheets used were FISHERBRAND plain glass microscope slides, catalog number 12-550C, sold by Fisher Scientific. The glass slides were 75 mm×50 mm. Before coating, the glass slides were cleaned by washing them in an ultrasonic bath (Fisher Scientific FS220) first in detergent for 3 minutes, followed by 3 washes in DI water for 3 minutes each. Dried the resulting cleaned glass sheets in an oven at 125° C. for 1 hour. The glass sheets were plasma treated prior to being coated using a Plasmatreat FG5001 S/N 3283in a 1000w power using a 15 degree rotating nozzle with 75 millimeter per second (mm/s) traverse speed and 40% to 50% overlap from serpentine pattern. The nozzle is 10 mm height from substrate.

Aluminum foil: Aluminum foil grade 1100 Temper 0 at 5 mils (0.127 mm) thickness. Prior to coating, the aluminum foils were cleaned by rinsing with isopropyl alcohol and allowed to air dry.

Preparation 1: preparation of a mixture containing Matrix Precursor 1 that is a polyfunctional curable organosiloxane that is a fluoro-substituted compound that is a polyfluoropolyether acrylate In a dry three neck flask, KRYTOX allyl ether (16 g, from Dupont, Mw about 3200 g/mol) in 1,3-bis(trifluoromethyl)benzene (30 g, from Synquest Laboratories Inc., catalog# 1800-3-05) was added dropwise into a mixture containing Dow Corning® MH1109 fluid (1.2 g, from Dow Corning Corp.), 1,3-bistrifluoromethylbenzene (70 g, from Synquest Laboratories Inc., catalog# 1800-3-05), 1:1 mixture of methyltriacetoxysilane and ethyltriacetoxysilane (0.02 g, from Dow Corning Corp.) and Pt catalyst (10 ppm of Pt, 1,3-diethenyl-1,1,3,3-tetramethyldisiloxane complexes (Platinum) in tetramethyldivinyldisiloxane with 27 wt % of Pt, from Dow Corning Corp., from Dow Corning Corp.) under nitrogen gas at 60° C. After addition, the mixture was stirred at 60° C. for 1 hour, and a mixture of allyl methacrylate (6 g, from Sigma Aldrich, catalog #234931-500m1) and butylated hydroxytoluene (BHT, 0.02 g, from Sigma Aldrich, catalog #w218405-1kg-k) was added carefully and stirred at 60° C. for another hour after addition. After cooled down to room temperature, diallyl maleate (0.02 g, from Sigma Aldrich, catalog #291226-250m1) was added into the mixture to give a mixture containing Matrix Precursor 1: the polyfluoropolyether acrylate. The mixture had 20% solids content.

Nanoporous filler 1 is a silica aerogel sold as Dow Corning® VM-2270 Aerogel Fine Particles (INCI name Silica Silylate) is a free flowing white powder having a bulk density of 40 to 100 kg/m³, an average particle size of from 5 to 15 μm (5 to 10 μm), a surface area of 600 to 800 m²/g, and a porosity >90%. The particles were completely hydrophobic (surface chemistry).

Nonporous nanoparticles 1 are nonporous, colloidal silica mono-dispersed at 30 wt % in methyl ethyl ketone and sold as ORGANOSILICASOL MEK-ST (Nissan Chemicals). The silica has an average particle size from 10 nm to 15 nm.

Comparative Example(s) used herein is/are non-invention example(s) that may help illustrate some benefits or advantages of the invention when compared to invention examples, which follow later. Comparative Examples should not be deemed to be prior art.

Comparative Example (CEx) 1: preparation of a comparative curable composition containing a matrix precursor, nonporous nanoparticles, and a modifier, but lacking (being free of) a nanoporous filler in which the dispersed phase is a gas. In a dry three-neck flask, a mixture of isobutanol (16.1 g, a vehicle), KAYARAD DPHA (1:1 mixture of dipentaerythritol hexaacrylate and dipentaerythritol pentaacrylate, Nippon Kayaku Co. Ltd., 21.3 g), and APTPDMS (an aminopropyl terminated poly(dimethylsiloxane)) (Gelest, catalog #dms-a12, kinematic viscosity 20-30 cSt (centistokes) at 25° C., 0.45 g) was heated to 50° C. and stirred for 1 hour. Then 3-methacryloxypropyl trimethoxysilane (Dow Corning Corp., 5.3 g, filler treating agent), Nonporous nanoparticles (1) (53.3 g), and DI water (0.49 g) were added, and the resulting mixture was stirred at 50° C. for another hour. Then the mixture was cooled to room temperature, and the mixture of Preparation (1) containing Matrix Precursor (1): the polyfluoropolyether acrylate of Preparation 1 (2 g) and IRGACURE 184 (BASF, 2 g, a photopolymerization initiator) were added to the mixture. The resulting solution was filtered by syringe filter (Whatman, PTFE with GMF, 30 mm diameter, 0.45 μm pore size) to give the curable composition of CEx 1. The curable composition is useful for forming a comparative hardcoat.

CEx A1: prepared comparative UV hardcoats as coatings on the PC sheets using the procedure described later for IEx Al except used the curable composition of CEx 1 instead of the inventive curable composition of IEx 1. Test data for pencil hardness, are reported later in Table 2.

CEx A2: prepared comparative UV hardcoats as coatings on the silicate glass sheets using the procedure described later for IEx A2 except used the curable composition of CEx 1 instead of the inventive curable composition of IEx 1. Test data for abrasion resistance, pencil hardness, haze, transmittance at 540 nm, and water contact angle are reported later in Table 3.

CEx A3: prepared comparative UV hardcoats as coatings on the aluminum foil substrate using the procedure described later for IEx A3 except used the curable composition of CEx 1 instead of the inventive curable composition of IEx 1. Test data for mandrel bend test and elongation at break are reported later in Table 4.

The invention is further illustrated by, and an inventive embodiment may include any combinations of features and limitations of, the non-limiting examples thereof that follow. The concentrations of ingredients in the compositions/formulations of the examples are determined from the weights of ingredients added unless noted otherwise.

Inventive Example (IEx) 1: preparation of an inventive curable composition. To 20 g of the curable composition of CEx 1 was admixed 0.2 g of Nanoporous Filler 1 to give the curable composition of IEx 1. The curable composition is useful for forming an inventive hardcoat.

Inventive Example 2: preparation of an inventive curable composition. To 20 g of the curable composition of CEx 1 was admixed 0.1 g of Nanoporous Filler 1 to give the curable composition of IEx 2. The curable composition is useful for forming an inventive hardcoat.

Table 1 below illustrates the constituents used to prepare curable compositions of CEx 1 and IEx 1, and IEx 2.

TABLE 1
comparative and inventive curable compositions

| | CEx 1 | IEx 1 | IEx 2 |
|---|---|---|---|
| | (parts by | (parts by | (parts by |
| Constituent: | weight) | weight) | weight) |
| Matrix precursors | 21.1 | 21.1 | 21.1 |
| Photopolymerization | 2.0 | 2.0 | 2.0 |
| Initiator | | | |
| Nonporous | 15.8 | 15.8 | 15.8 |
| Nanoparticle filler | | | |
| Nonporous | 5.7 | 5.7 | 5.7 |
| Nanoparticle Filler | | | |
| Treating Agents | | | |
| Vehicle (Solvent) | 54.5 | 54.5 | 54.5 |
| Modifier- | 0.4 | 0.4 | 0.4 |
| polyfluoropolyether | | | |
| acrylate | | | |
| Modifier- | 0.4 | 0.4 | 0.4 |
| aminopropyl | | | |
| terminated | | | |
| poly(dimethylsiloxane) | | | |
| Nanoporous filler 1 | 0.0 | 1.0 | 0.5 |
| Total Wt of | 100.0 | 101.0 | 100.5 |
| Ingredients: | | | |

IEx A1 and IEx B1: UV cured hardcoats on PC (polycarbonate) sheets. Applied coatings of the curable compositions of IEx 1 or IEx 2, respectively, on PC sheets with drawdown bar with 1, 2, 3, or 4 mil gap (i.e., 0.025, 0.051, 0.076, or 0.1 mm gap) to give laminates. Then the vehicle was evaporated from the resulting coating by placing the laminate in an oven for 10 minutes at 100° C. Samples were then UV cured with 2000 mJ/cm² of UV radiation (Fusion UV Systems, Inc. UV oven with P300MT power supply) to give hardcoats of IEx A1 and IEx B1, respectively. The physical properties of the resulting hardcoats of IEx A1 and B1 were measured by Pencil Hardness test and obtained the data shown below in Table 2.

TABLE 2
Pencil Hardness of UV Cured Hardcoats on PC sheets

| | UV Cured Hardcoats on PC | | |
|---|---|---|---|
| Applied Thickness | Comparative | Inventive | Inventive |
| (before curing) | Example A1 | Example A1 | Example B1 |
| 1 mil (25.4 μm) | HB | 3H | H |
| 2 mils (50.8 μm) | F | 3H | H |
| 3 mils (76.2 μm) | F | 3H | H |
| 4 mils (101.6 μm) | F | 3H | 2H |

As seen from the data in Table 2, physical properties as measured by pencil hardness of coating films was improved by addition of nanoporous fillers. For example in Table 2, with the 4 mils (101.6 μm) thick coating, the pencil hardness of the coating of IEx A1 is 3H, which is three grades higher than the pencil hardness F for the 4 mils thick coating of CEx A1.

IEx A2 and IEx B2: UV cured hardcoats on silicate glass sheets. Applied coatings on silicate glass sheets by spin-coating the curable composition of IEx 1 or IEx 2, respectively, using a Karl Suss spin-coater at 200 rpm for 20 seconds, then 1,000 rpm for 30 seconds to give laminates. Then the vehicle was evaporated from the resulting coating by placing the laminate in an oven for 10 minutes at 100° C. Samples were then UV cured with 3000 mJ/cm² of UV radiation (Fusion UV Systems, Inc. UV oven with P300MT power supply) to give hardcoats of IEx A2 and IEx B2, respectively. The physical properties of the resulting hardcoats of IEx A1 and B1 were measured by abrasion resistance, haze, pencil hardness, transmittance at 540 nm, and water contact angle. The data are shown below in Table 3A. The physical properties of pencil hardness and anti-glare were measured and the data are shown later in Table 3A.

TABLE 3A
Characterizations of UV Cured Hardcoats on silicate glass sheets

| | UV Cured Hardcoats on glass | | |
|---|---|---|---|
| | Comparative | Inventive | Inventive |
| Test (after curing) | Example A2 | Example A2 | Example B2 |
| Abrasion Resistance rating | | | |
| After 10 abrasion cycles | 1.5 | 1 | 1.5 |
| After 25 abrasion cycles | 2 | 1 | 1 |
| After 100 abrasion cycles | 3 | 1.5 | 1 |
| Haze (%) | 0.3 | 11.2 | 2.8 |
| Pencil Hardness | 8H to 9H | 8H to 9H | 8H to 9H |
| Transmittance at 540 nm (%) | 92.7 | 90.3 | 91.8 |
| WCA (°) | 111 | 115 | 115 |

As seen from the data in Table 3A, abrasion resistance of hardcoats was improved by the inclusion of Nanoporous filler 1. For example, the abrasion resistance rating after 100 abrasion cycles for the comparative coating of CEx A2 was 3 (moderate scratches to the coating), whereas the abrasion resistance rating after 100 cycles for the inventive coating of IEx B2 was 1 (no damage to the hardcoat).

TABLE 3B
Characterizations of UV Cured Hardcoats on polycarbonate sheets

| Test (after curing) | Inventive Example A1 | Comparative Example A1 |
|---|---|---|
| Anti-Glare Rating | Good | Poor |
| Pencil Hardness | 5H | H |
| HCA (°) | 64 | 65 |
| WCA (°) | 110 | 111 |

As seen from the data in Table 3B, addition of nanoporous filler provides hard coating with improved pencil hardness and anti-glare properties. From Table 3B the pencil hardness of 5H for the inventive hardcoat of IEx A1 is four grades higher than the pencil hardness H for the comparative coating of CEx A1. Also, the anti-glare rating for the inventive hardcoat of IEx A1 is good, whereas the anti-glare rating for the comparative coating of CEx A1 is poor.

IEx A3: UV cured hardcoats on aluminum foil substrate. Coatings were prepared with drawdown bar with 1 mil (0.0254 mm) gap to give a laminate. After coating, the solvent was evaporated from the coating by placing the laminate in an oven for 10 minutes at 80° C. Samples were then UV cured with 3000 mJ/cm² of UV radiation (Fusion UV Systems, Inc. UV oven with P300MT power supply). The physical properties of the coating as related to the Mandrel Bend Test and elongation-at-break were collected and the data are shown below in Table 4

TABLE 4
Characterization on UV Cured coating on Aluminum foil

| | Mandrel | | |
|---|---|---|---|
| | Diameter, | Pass/Fail after | |
| | in. (mm) | bending | Elongation, % |
| CE A3 | 1″ (25 mm) | Pass (No cracking) | 3.3 |
| | 3/4″ (19 mm) | Fail (Cracking) | NM |
| IEx A3 | 1″ (25 mm) | Pass (No cracking) | NM |
| | 3/4″ (19 mm) | Pass (No cracking) | NM |
| | 3/8″ (9.5 mm) | Pass (No cracking) | 9.0 |
| | 5/16″ (7.9 mm) | Fail (Cracking) | NM |
| | 1/4″ (6.4 mm) | Fail (Cracking) | NM |

NM means not measured.

As seen from data in Table 4, addition of nanoporous filler provides increase in elongation of coated hard coat on substrate.

The below claims are incorporated by reference here, and the terms “claim” and “claims” are replaced by the term “aspect” or “aspects,” respectively. Embodiments of the invention also include these resulting numbered aspects.

1. A curable composition consisting essentially of the following mixture of constituents: a matrix precursor containing curable groups; a nanoporous filler in which the dispersed phase is a gas; and nonporous nanoparticles; wherein the nanoporous filler is at a concentration of from 0.1 to 10 weight percent (wt %), based on total weight of the curable composition; and wherein the nonporous nanoparticles are at a concentration from 5 to 60 wt %, based on total weight of the curable composition.

2. The curable composition of claim 1 wherein the matrix precursor comprises a sol-gel, a polyfunctional isocyanate, a polyfunctional acrylate, or a polyfunctional curable organosiloxane.

3. The curable composition of claim 1 wherein the nanoporous filler is an aerogel, a metal-organic framework, a zeolite, or a combination of any two or more thereof, wherein the aerogel, metal-organic framework or zeolite comprises particles, which are dispersed in the matrix precursor.

4. The curable composition of claim 3 wherein the nanoporous filler is a silica aerogel and the silica aerogel comprises particles having a diameter of from 1 micrometer (μm) to 50 μm.

5. The curable composition of claim 1 further consisting essentially of a constituent: a curing agent for the matrix precursor, wherein the curing agent is a curing initiator or a curing catalyst.

6. The curable composition of claim 1 wherein the mixture further consists essentially of a constituent: a modifier containing, per molecule, one or more functional groups useful for forming one or more covalent bonds to at least one of the aforementioned constituents such that the modifier would form a covalently-bound portion of the hardcoat, wherein the modifier is dispersed in the curable composition at from 0.05 to 5 wt %, based on total weight of the curable composition.

7. The curable composition of claim 6, wherein the modifier is:
a fluoro-substituted compound having at least one unsaturated aliphatic group;
an organopolysiloxane having at least one acrylate group; or
a combination of the fluoro-substituted compound and the organopolysiloxane.

8. The curable composition of claim 1 consisting essentially of a mixture of constituents: the matrix precursor containing curable groups, wherein the matrix precursor is a polyfunctional acrylate; a curing agent for the matrix precursor, wherein the curing agent comprises a photopolymerization initiator; the nanoporous filler, wherein the nanoporous filler is a silica aerogel; the nonporous nanoparticles, wherein the nonporous nanoparticles are colloidal silica; and a modifier comprising a combination of a fluoro-substituted compound having at least one unsaturated aliphatic group and an organopolysiloxane having at least one acrylate group.

9. A hardcoat prepared by subjecting the curable composition of claim 1 to a curing condition so as to prepare a hardcoat comprising constituents:
a host matrix;
a nanoporous filler in which the dispersed phase is a gas; and
nonporous nanoparticles having a maximum diameter less than 100 nanometers;
Wherein the nanoporous filler is disposed in the host matrix at a concentration of from 0.1 to 10 weight percent (wt %); and
Wherein the nonporous nanoparticles are dispersed in the host matrix at a concentration from 5 to 60 wt %, all based on total weight of the hardcoat; and
Optionally further comprising a modifier, when present in the curable composition, wherein the modifier has become covalently-bound to a portion of the hardcoat.

10. A hardcoat comprising constituents:
a host matrix;
a nanoporous filler in which the dispersed phase is a gas; and
nonporous nanoparticles having a maximum diameter less than 100 nanometers;
Wherein the nanoporous filler is disposed in the host matrix at a concentration of from 0.1 to 10 weight percent (wt %), based on total weight of the hardcoat; and
Wherein the nonporous nanoparticles are dispersed in the host matrix at a concentration from 5 to 60 wt %, based on total weight of the hardcoat.

11. A coating composition useful for coating a substrate, the coating composition comprising the constituents of the curable composition of claim 1 and a vehicle, wherein the constituents of the curable composition are dispersed in the vehicle and the vehicle has a lower boiling point than boiling points of the other constituents of the coating composition.

12. A method of preparing the curable composition of claim 1, the method comprising a step of removing the vehicle from a coating composition comprising the constituents of the curable composition and a vehicle, wherein the constituents of the curable composition are dispersed in the vehicle and the vehicle has a lower boiling point than boiling points of the other constituents of the coating composition, to give the curable composition, wherein the curable composition is substantially free or free of the vehicle.

13. A method of preparing a hardcoat, the method comprising subjecting a curable composition of claim 1, to a curing condition so as to prepare a hardcoat comprising constituents:
a host matrix;
a nanoporous filler in which the dispersed phase is a gas; and
nonporous nanoparticles having a maximum diameter less than 100 nanometers;
Wherein the nanoporous filler is disposed in the host matrix at a concentration of from 0.1 to 10 weight percent (wt %); and
Wherein the nonporous nanoparticles are dispersed in the host matrix at a concentration from 5 to 60 wt %, all based on total weight of the hardcoat; and
Optionally further comprising a modifier, when present in the curable composition, wherein the modifier has become covalently-bound to a portion of the hardcoat.

14. An article comprising the coating composition of claim 11 disposed on a substrate.

15. An article comprising the hardcoat of claim 9 disposed on a substrate.
